(19) United States
(12) Patent Application Publication
(10) Pub. No.: US 2016/0134568 A1
(43) Pub. Date: May 12, 2016

(54) USER INTERFACE ENCAPSULATION IN CHAT-BASED COMMUNICATION SYSTEMS

(71) Applicants: Thomas Y. Woo, Short Hills, NJ (US); James R. Ensor, Red Bank, NJ (US); Markus A. Hofmann, Fair Haven, NJ (US)

(72) Inventors: Thomas Y. Woo, Short Hills, NJ (US); James R. Ensor, Red Bank, NJ (US); Markus A. Hofmann, Fair Haven, NJ (US)

(73) Assignee: ALCATEL-LUCENT USA INC., Murray Hill, NJ (US)

(21) Appl. No.: 14/537,416

(22) Filed: Nov. 10, 2014

(51) Int. Cl. H04L 12/58; H04L 29/06

(52) U.S. Cl. CPC H04L 51/02; H04L 51/046; H04L 65/403

(57) ABSTRACT

A chat-based communication capability is presented. The chat-based communication capability may support encapsulation of a user interface within a chat session. The encapsulation of a user interface within a chat session may be provided by dynamically creating the user interface within the chat session. The creation of a user interface within a chat session may be supported by determining that the user interface is to be created within the chat session and propagating, toward a device supporting the chat session, information configured for use by the device to create the user interface within the chat session. The creation of a user interface within a chat session may be supported by receiving information configured for use by a device to create the user interface within the chat session and initiating creation of the user interface within the chat session based on the information configured for use by the device to create the user interface within the chat session.

### TECHNICAL FIELD

The disclosure relates generally to communication systems and, more specifically but not exclusively, to providing user interface encapsulation in chat-based communication systems.

### BACKGROUND

Existing technology provides people with multiple, distinct paradigms for communicating. These communication paradigms are typically associated with specific types of communication interaction types. For example, chat-based communication paradigms may be used for human-to-human interaction, menu-based communication paradigms may be used for human-to-computer interaction, and so forth. While such communication paradigms, and associated communication interaction types, often serve their specific functions well, such communication paradigms also tend to place a significant demand on users using them (e.g., typically requiring the users to learn specific, often distinct, and sometimes conflicting vocabulary and syntax). Furthermore, existing limitations of chat-based communication paradigms may place further demands on users using a chat-based communication paradigm, especially when the users attempt to perform other functions while using the chat-based communication paradigm.

### SUMMARY OF EMBODIMENTS

Various deficiencies in the prior art are addressed by embodiments for supporting user interface encapsulation within a chat-based system.

In at least some embodiments, an apparatus includes a processor and a memory communicatively connected to the processor, where the processor is configured to determine, based on detection of a trigger condition, that a user interface is to be created within a chat session supported by a chat application of a device, and propagate, toward the device, information configured for use by the device to create the user interface within the chat session.

In at least some embodiments, a method includes using a processor and a memory for determining, based on detection of a trigger condition, that a user interface is to be created within a chat session supported by a chat application of a device, and propagating, toward the device, information configured for use by the device to create the user interface within the chat session.

In at least some embodiments, an apparatus includes a processor and a memory communicatively connected to the processor, where the processor is configured to receive, at a device comprising a chat application configured to support a chat session, information configured for use by the device to create a user interface within the chat session, and initiate creation of the user interface within the chat session based on the information configured for use by the device to create the user interface within the chat session.

In at least some embodiments, a method includes using a processor and a memory for receiving, at a device comprising a chat application configured to support a chat session, information configured for use by the device to create a user interface within the chat session, and initiating creation of the user interface within the chat session based on the information configured for use by the device to create the user interface within the chat session.

### BRIEF DESCRIPTION OF THE DRAWINGS

The teachings herein can be readily understood by considering the detailed description in conjunction with the accompanying drawings, in which:

FIG. 1 depicts an exemplary chat-based system configured to support chat-based communications for multiple communication interaction types;

FIG. 2 depicts an exemplary embodiment of a method for supporting chat-based communications for multiple communication interaction types;

FIG. 3 depicts an exemplary embodiment of a method for supporting chat-based communications;

FIG. 4 depicts an exemplary embodiment for supporting user interface encapsulation within a chat session supported by the exemplary chat-based system of FIG. 1;

FIG. 5 depicts an exemplary embodiment of a method for supporting user interface encapsulation within a chat session supported by a chat-based system;

FIG. 6 depicts an exemplary user interface illustrating encapsulation of a user interface within a chat session supported by a chat-based system; and

FIG. 7 depicts a high-level block diagram of a computer suitable for use in performing functions presented herein.

To facilitate understanding, identical reference numerals have been used, where possible, to designate identical elements common to the figures.

### DETAILED DESCRIPTION OF EMBODIMENTS

A chat-based communication capability is presented herein. In at least some embodiments, the chat-based communication capability utilizes a chat-based communication paradigm to support one or more communication interaction types not typically supported by chat-based communication paradigms.

In at least some embodiments, the chat-based communication capability may support chat-based communication between a human entity and a non-human entity (e.g., a device, a program running on a device, a process, an organization, or the like). In at least some embodiments, in addition to or in place of human-human communication typically supported by chat applications, a chat application may be configured to support one or more other communication interaction types for communication between a human entity and a non-human entity, such as one or more of human-device communications between a human and a device (e.g., a content server, a printer, a camera, or the like), human-program communications between a human and a program (e.g., an online e-commerce program, a restaurant order and payment processing program, a human resources program, or the like), human-process communications between a human and a process (e.g., a group conversation, a collaborative session, a digital conference, or the like), human-organization communications between a human and an organization (e.g., a business, a not-for-profit organization, an educational organization, or the like), or the like, as well as various combinations thereof.

In at least some embodiments, the chat-based communication capability may support chat-based communication between multiple non-human entities (e.g., where the non-human entities may include devices, programs, processes, organizations, or the like). In at least some embodiments, a chat application may be configured to support one or more communication interaction types for communication between multiple non-human entities, such as one or more of device-device communications between devices (which also may be referred to herein as machine-to-machine (M2M) communications), device-program communications between a device and a program, program-program communications between programs, device-process communications between a device and a process, program-process communications between a program and a process, process-process communications, and so forth.

Various embodiments of the chat-based communication capability provide a convenient and uniform way for human and non-human entities to communicate using different communication interaction types (e.g., to communicate with humans, to interact with devices, to interface with computer programs, to participate in processes, to interact with organizations, or the like) using a common chat-based communication paradigm. Various embodiments of the chat-based communication capability provide a convenient way for human and non-human entities to easily and seamlessly move between different communication interaction types. Various embodiments of the chat-based communication capability provide a comprehensive chat-based communication interface, supporting various communication interaction types, which allow human and non-human entities to participate in a wide range of communication interaction types more readily, intuitively, quickly, and simply.

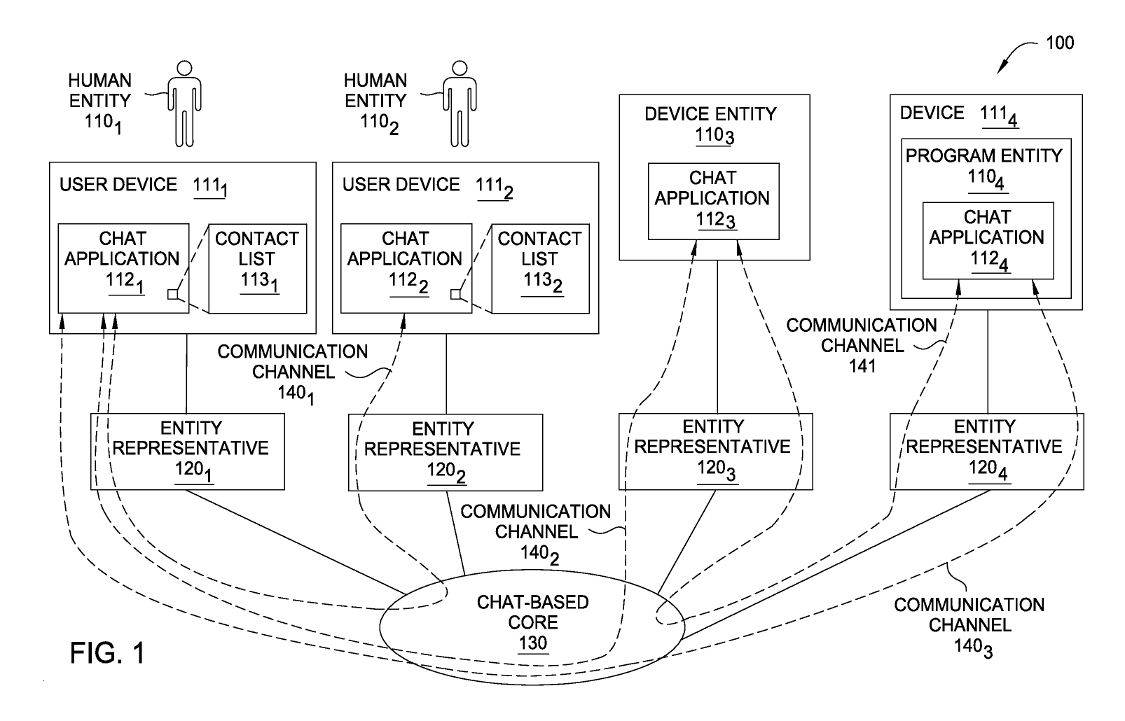

These and various other embodiments and advantages of the chat-based communication capability may be better understood by way of reference to the exemplary chat-based system of FIG. 1.

FIG. 1 depicts an exemplary chat-based system configured to support chat-based communications for multiple communication interaction types.

The chat-based system 100 includes a set of entities 110₁-110₄ (collectively, entities 110), a set of entity representatives 120₁-120₄ (collectively, entity representatives 120) associated with respective entities 110₁-110₄, and a chat-based core 130. The entities 110 include human entities (illustratively, a human entity 110₁ and a human entity 110₂) and non-human entities (illustratively, device entity 110₃ and a program entity 110₄). The chat-based system 100 is configured to support multiple communication interactions types between entities 110, which may include chat-based communications involving a human entity (primarily depicted and described herein from the perspective of the human entity 110₁) or chat-based communications that do not involve a human entity. The chat-based communications involving a human entity may include chat-based communication between human entities (e.g., a typical chat session between human entity 110₁ and human entity 110₂), chat-based communication between a human entity and a non-human entity (e.g., again, primarily depicted and described herein from the perspective of human entity 110₁), or the like. The chat-based communications that do not involve a human entity may include chat-based communications between devices, chat-based communications between a device and a program, chat-based communications between programs, or the like. The entity representatives 120 and chat-based core 130 are configured to facilitate communications between various entities 110 as discussed in additional detail below.

As discussed above, chat-based system 110 may support multiple communication interaction types for a human entity (illustratively, for human entity 110₁). The human entity 110₁ is using an associated user device 111₁ supporting a chat application 112₁. The user device 111₁ of human entity 110₁ may be a computer, smartphone, or any other device suitable for executing chat application 112₁. The chat application 112₁ is an enhanced chat application that is configured to provide more functions than a typical chat application (namely, chat application 112₁ is configured to support multiple communication interaction types in addition to human-to-human communications). The chat application 112₁ is executing on user device 111₁ such that the human entity 110₁ may utilize chat application 112₁ to engage in various types of chat-based communication interactions (e.g., human-to-human, human-device, human-program, or the like) as discussed further below. The chat application 112₁ provides a chat-based communication interface via which human entity 110₁ may provide information for propagation to other entities 110 and via which human entity 110₁ may receive information from other entities 110. The chat application 112₁ supports establishment of communication channels between chat application 112₁ and chat applications running on other entities 110 (described below), such that information provided by human entity 110₁ via the chat-based communication interface of chat application 112₁ may be propagated to other entities 110 and, similarly, such that information from other entities 110 may be propagated to chat application 112₁ for presentation to human entity 110₁. The chat application 112₁ has associated therewith a contact list 113₁, which includes a list of other entities 110 that are associated with human entity 110₁ via chat application 112₁ (illustratively, human entity 110₂, device entity 110₃, and program entity 110₄, as discussed further below) and, thus, with which chat application 112₁ may support communication channels for chat-based communications with other entities 110. The chat application 112₁, including associated contact list 113₁, may be adapted for display to human entity 110₁ via one or more presentation interfaces of user device 111₁ (although it will be appreciated that chat application 112₁ also may continue to run even when not displayed). It will be appreciated that, although primarily depicted and described with respect to embodiments in which chat application 112₁ runs exclusively on user device 111₁ (and, similarly, associated contact list 113₁ is stored on user device 111₁), at least some components or functions of chat application 112₁ may also or alternatively be running (and, similarly, at least a portion of contact list 113₁ also or alternatively may be stored) on one or more other elements (e.g., entity representative 120₁, chat-based core 130, one or more other elements, or the like, as well as various combinations thereof).

The chat-based system 100 supports a typical human-to-human interaction between human entity 110₁ and human entity 110₂. The human entity 110₂ is using an associated user device 111₂ supporting a chat application 112₂. The user device 111₂ of human entity 110₂ may be a computer, smartphone, or any other device suitable for executing chat application 112₂. The chat application 112₂ may be a typical chat application that only supports a single interaction type (i.e., human-to-human communications) or may be an enhanced chat application (e.g., such as chat application 112₁ being used by human entity 110₁). The chat application 112₂ supports a chat-based communication interface via which human entity 110₂ may provide information for propagation to human entity 110₁ and via which human entity 110₂ may receive information from human entity 110₁. The chat application 112₂ has associated therewith a contact list 113₂, which includes a list of other entities 110 that are associated with human entity 110₂ via chat application 112₂ (illustratively, human entity 110₁). The chat application 112₂, including associated contact list 113₂, may be adapted for display to human entity 110₂ via one or more presentation interfaces of user device 111₂. The chat-based system 100 supports establishment of a communication channel 140₁ between the chat application 112₁ of user device 111₁ and the chat application 112₂ of user device 111₂. The communication channel 140₁ between the chat application 112₁ of user device 111₁ and the chat application 112₂ of user device 111₂ supports propagation of chat-based communication between human entity 110₁ and human entity 110₂. For example, human entity 110₁ may use the chat-based communication interface of chat application 112₁ to enter and submit messages intended for human entity 110₂ (which are delivered to chat application 112₂ of user device 111₂ via communication channel 140₁ and presented to human entity 110₂ via the chat-based communication interface of chat application 112₂ of user device 111₂) and, similarly, human entity 110₂ may use the chat-based communication interface of chat application 112₂ to enter and submit messages intended for human entity 110₁ (which are delivered to chat application 112₁ of user device 111₁ via communication channel 140₁ and presented to human entity 110₁ via the chat-based communication interface of chat application 112₁ of user device 111₁). In this manner, human entity 110₁ and human entity 110₂ may carry on a conversation in real time. The typical interaction between human entities within the context of a chat session will be understood by one skilled in the art and, thus, a description of such interaction is omitted. The communication channel 140₁ also traverses entity representatives 120₁ and 120₂ and chat-based core 130, one or more of which may perform various functions in support of the chat-based communication between human entity 110₁ and human entity 110₂ via communication channel 140₁.

The chat-based system 100 supports human-device interaction between human entity 110₁ and entity 110₃, which is a device entity. The device entity 110₃ may be any type of device with which user device 111₁ of human entity 110₁ may communicate. For example, device entity 110₃ may be a network device (e.g., a database from which human entity 110₁ may request information, a content server from which human entity 110₁ may request content or on which human entity 110₁ may store content, or the like), a datacenter device (e.g., a host server hosting a virtual machine accessible to human entity 110₁, a file system accessible to human entity 110₁, or the like), a device available on a local area network (e.g., a computer, a storage device, a printer, a copier, a scanner, or the like), a smart device for a smart environment (e.g., a sensor, an actuator, a monitor, a camera, an appliance, or the like), an end-user device (e.g., a computer, a smartphone, a television, or the like), a vehicle-mounted communication device, a near-field communication device, or the like. The device entity 110₃ includes a chat application 112₃. The chat-based system 100 supports establishment of a communication channel 140₂ between the chat application 112₁ of user device 111₁ and the chat application 112₃ of device entity 110₃. The chat application 112₃ supports a chat-based communication interface via which device entity 110₃ may provide information for propagation to human entity 110₁ and via which device entity 110₃ may receive information from human entity 110₁. The chat-based communication interface may provide an interface between the chat application 112₃ (including the communication channel 140₂ established with chat application 112₃) and one or more modules or elements of device entity 110₃ (e.g., modules or elements configured to process information received via communication channel 140₂, modules or elements configured to provide information for transmission via communication channel 140₂, or the like, as well as various combinations thereof). The chat application 112₃ may have associated therewith a contact list 113₃, which includes a list of other entities 110 that are associated with device entity 110₃ via chat application 112₃ (illustratively, human entity 110₁). The chat application 112₃ is not expected to include a display interface or component, as the device entity 110₃ is expected to participate in chat-based communication via communication channel 140₂ independent of any human interaction.

The communication channel 140₂ between the chat application 112₁ of user device 111₁ and the chat application 112₃ of device entity 110₃ supports propagation of chat-based communication between human entity 110₁ and device entity 110₃. The communication channel 140₂ between the chat application 112₁ of user device 111₁ and the chat application 112₃ of device entity 110₃ may support various types of communication between human entity 110₁ and device entity 110₃, where the types of communication supported may depend on the device type of device entity 110₃. For example, human entity 110₁ may use a chat-based communication interface of chat application 112₁ to send a request for information or content to device entity 110₃ via communication channel 140₂ (e.g., a request for a video file, a request for an audio file, a request for status information from a sensor, a request for status information from a vehicle information system, or the like), and device entity 110₃ may respond to the request by using a chat-based communication interface of chat application 112₃ to send the requested information or content to chat application 112₁ via communication channel 140₂ for making the information or content accessible to human entity 110₁. For example, human entity 110₁ may use a chat-based communication interface of chat application 112₁ to send a control command to device entity 110₃ via communication channel 140₂ (e.g., a command sent to a camera to control reconfiguration of the camera, a command sent to an actuator to control the actuator, a command sent to a printer to control configuration of the printer, a command sent to a device hosting a file system to control retrieval of data from the file system, or the like), and device entity 110₃ may respond to the control command by using a chat-based communication interface of chat application 112₃ to send an associated command result to chat application 112₁ via communication channel 140₂ for informing the human entity 110₁ of the result of execution of the command. For example, device entity 110₃ may use a chat-based communication interface of chat application 112₃ to send information (e.g., a sensor status of a sensor, an indicator that a threshold of a sensor has been satisfied, an actuator status of an actuator, a measurement from a monitor, a toner or paper status of a printer, an available storage status of a digital video recorder, an indication of a potential security breach of a home network, an indicator of a status or reading of a vehicle information and control system, or the like) to chat application 112₁ via communication channel 140₂ for providing the information to human entity 110₁. It will be appreciated that the foregoing examples are merely a few of the various ways in which communication channel 140₂ between the chat application 112₁ of user device 111₁ and the chat application 112₃ of device entity 110₃ may be used to support chat-based communication between human entity 110₁ and device entity 110₃.

The communication channel 140₂ between the chat application 112₁ of user device 111₁ and the chat application 112₃ of device entity 110₃ may also traverse entity representatives 120₁ and 120₃ and chat-based core 130, one or more of which may perform various functions in support of chat-based communication between human entity 110₁ and device entity 110₃ via communication channel 140₂. For example, for a communication from human entity 110₁ to device entity 110₃, the communication may be routed via a path including entity representative 120₁, chat-based core 130, and entity representative 120₃, one or more of which may process the communication to convert the communication from a format supported by human entity 110₁ (e.g., natural language) to a format supported by device entity 110₃ (e.g., a machine-based format which is expected to vary across different types of devices). For example, for a communication from device entity 110₃ to human entity 110₁, the communication may be routed via a path including entity representative 120₃, chat-based core 130, and entity representative 120₁, one or more of which may process the communication to convert the communication from a format supported by device entity 110₃ (e.g., a machine-based format, which is expected to vary across different types of devices) to a format supported by human entity 110₁ (e.g., natural language). The entity representatives 120₁ and 120₃ and chat-based core 130 may operate to provide these types of conversions under various conditions in support of communications exchanged between human entity 110₁ and device entity 110₃ via communication channel 140₂.

For example, where device entity 110₃ is a video server, the human-device interaction between human entity 110₃ and the video server may proceed as follows: (1) human entity 110₁ may select a representation of the video server via chat application 112₁ and enter and submit, via a chat-based communication interface of chat application 112₁, a request such as “I want the latest movie to win a best picture award?”; (2) the request is propagated toward the chat application 112₃ of video server via communication channel 140₂, (3) one or more of entity representative 120₁, chat-based core 130, or entity representative 120₃ operates on the request in order to convert the request into a device language supported by the video server (e.g., REQUEST: MOVIE, METADATA: AWARD, BEST PICTURE WINNER, LATEST) before the request is received by the video server, (4) the chat application 112₃ of video server receives the request and passes the request to a video identification and retrieval module of the video server via a chat-based communication interface of chat application 112₃, (5) the video identification and retrieval module of the video server identifies and retrieves the requested movie and provides the requested movie to chat application 112₃ of the video server, via a chat-based communication interface of chat application 112₃, for propagation toward user device 111₁ via communication channel 140₂ for making the movie accessible to human entity 110₁, and (6) chat application 112₁ of user device 111₁ receives movie content from the video server via communication channel 140₂ and makes the video content accessible to human entity 110₁ (e.g., via the chat-based communication interface of chat application 112₁ or by passing the video content to one or more other modules on user device 111₁).

For example, where device entity 110₃ is a sensor, the human-device interaction between human entity 110₃ and the sensor may proceed as follows: (1) human entity 110₁ may select a representation of the sensor via chat application 112₁ on user device 111₁ and enter and submit, via a chat-based communication interface of chat application 112₁, a query such as “what is the latest reading?”, (2) the query is propagated toward the chat application 112₃ of sensor via communication channel 140₂, (3) one or more of entity representative 120₁, chat-based core 130, or entity representative 120₃ on the communication channel 140₂ operates on the query in order to convert the query into a formatted query using device language supported by the sensor (e.g., REQUEST: DEVICE READING, LATEST) before providing the query to the sensor, (4) the chat application 112₃ of sensor receives the formatted query and passes the formatted query to a sensor reading module of the sensor via a chat-based communication interface of chat application 112₃, (5) the sensor reading module of the sensor identifies and obtains the requested sensor reading and provides a formatted sensor reading response to chat application 112₃ of the sensor, via a chat-based communication interface of chat application 112₃, for propagation toward user device 111₁ via communication channel 140₂ for making the requested sensor reading accessible to human entity 110₁, (6) one or more of entity representative 120₃, chat-based core 130, or entity representative 120₁ operates on the formatted sensor reading response in order to convert the formatted sensor reading response into a natural language sensor reading response before providing the sensor reading to human entity 110₁, and (7) chat application 112₁ of user device 111₁ receives the natural language sensor reading response via communication channel 140₂ and presents the natural language sensor response to human entity 110₁ via the chat-based communication interface of the chat application 112₁.

For example, where device entity 110₃ is a printer, the human-device interaction between human entity 110₃ and the printer may proceed as follows: (1) human entity 110₁ may select a representation of the printer via chat application 112₁ on user device 111₁ and enter and submit, via a chat-based communication interface of chat application 112₁, a request such as “please print document1” while also attaching a copy of document1, (2) the request is propagated toward the chat application 112₃ of printer via communication channel 140₂, (3) one or both of chat-based core 130 and entity representative 120₃ operates on the request in order to convert the request into a formatted request using device language supported by the printer before providing the request to the printer, (4) the chat application 112₃ of printer receives the formatted request and associated document and passes the formatted request and associated document to a print control module of the printer via a chat-based communication interface of chat application 112₃, (5) the print control module of the printer initiates printing of the document and, when printing is complete, provides a formatted print status response to chat application 112₃ of the printer, via a chat-based communication interface of chat application 112₃, for propagation toward user device 111₁ via communication channel 140₂ for making the print status accessible to human entity 110₁, (6) one or both of entity representative 120₃ or chat-based core 130 operates on the formatted print status response in order to convert the formatted print status response into a natural language print status response before providing the print status to human entity 110₁, and (7) chat application 112₁ of user device 111₁ receives the natural language print status response and presents the natural language print status response to human entity 110₁ via the chat-based communication interface of the chat application 112₁.

It will be appreciated that the foregoing examples represent merely a few of the various ways in which chat-based system 100 may support human-device interactions between human entity 110₁ and device entity 110₃ via the communication channel 140₂ between chat application 112₁ and chat application 112₃.

The chat-based system 100 supports human-program interaction between human entity 110₁ and entity 110₄, which is a program entity. The program entity 110₄ may be any type of program on any type of device with which user device 111₁ of human entity 110₁ may communicate. For example, program entity 110₄ may be an online ordering program (e.g., an e-commerce shopping program, an order and payment processing program of a restaurant, or the like), an online service provider program (e.g., a program of a telecommunications service provider, a program of an electricity provider, or the like), a program available on a network device or datacenter device (e.g., an application hosted in the network or datacenter), an ordering program of a business, a concierge program of a hotel, a taxi scheduling program of a taxi company, a vehicle information and control program of a vehicle, or the like. The program entity 110₄ includes a chat application 112₄. The chat-based system 100 supports establishment of a communication channel 140₄ between the chat application 112₄ of user device 111₁ and the chat application 112₄ of program entity 110₄ running on device 111₄). The chat application 112₄ supports a chat-based communication interface via which program entity 110₄ may provide information for propagation to human entity 110₁ and via which program entity 110₄ may receive information from human entity 110₁. The chat-based communication interface may provide an interface between the chat application 112₄ (including the communication channel 140₄ established with chat application 112₃) and one or more modules or elements of program entity 110₄ (e.g., modules or elements configured to process information received via communication channel 140₃, modules or elements configured to provide information for transmission via communication channel 140₃, or the like, as well as various combinations thereof). The chat application 112₄ may have associated therewith a contact list 113₄, which includes a list of other entities 110 that are associated with program entity 110₄ via chat application 112₄ (illustratively, human entity 110₁). The chat application 112₄ is not expected to include a display interface or component, as the program entity 110₄ is expected to participate in chat-based communication via communication channel 140₃ independent of any human interaction. The communication channel 140₃ between the chat application 112₁ of user device 111₁ and the chat application 112₄ of program entity 110₄ may support various types of communication between human entity 110₁ and program entity 110₄, where the types of communication supported may depend on the program type of program entity 110₄. The communication channel 140₃ between the chat application 112₁ of user device 111₁ and the chat application 112₄ of program entity 110₄ may also traverse entity representatives 120₁ and 120₄ and chat-based core 130, one or more of which may perform various functions in support of communication between human entity 110₁ and program entity 110₄ via communication channel 140₄. The human-program interaction between human entity 110₁ and program entity 110₄ via communication channel 140₄ is expected to be similar to the human-device interaction human entity 110₁ and device entity 110₃ via communication channel 140₃ and, thus, detailed examples are omitted. For example, human entity 110₁ may use a chat-based communication interface of chat application 112₁ to request and receive reservations from a restaurant reservation scheduling program, a dentist office patient scheduling program may use a chat-based communication interface of chat application 112₄ to request and receive confirmation that human entity 110₁ intends on keeping his or her scheduled appointment, and so forth. It will be appreciated that such programs will be executing on devices (e.g., servers, physical resources hosting VMs, computers, or the like) and, thus, that various embodiments discussed herein with respect to human-device interaction between human entity 110₁ and device entity 110₃ also may be used for human-program interaction between human entity 110₁ and program entity 110₄. Namely, in at least some embodiments, human-program interaction between human entity 110₁ and program entity 110₄ also may be considered to be human-device interaction between human entity 110₁ and a device hosting the program entity 110₄.

The chat-based system 100 also may be configured to support other communication interaction types between human entity 110₁ and other types of non-human entities. For example, chat-based system 100 also may be configured to support human-process interaction between human entity 110₁ and one or more processes (e.g., a digital conference, a collaborative session, or the like). For example, chat-based system 100 also may be configured to support human-organization interaction between human entity 110₁ and one or more organizations (e.g., a business, a not-for-profit organization, an educational organization, or the like). The chat-based system 100 also may be configured to support other communication interaction types between human entity 110₁ and other types of non-human entities. For example, other types of non-human entities may include locations (e.g., a store, a restaurant, a library, or the like), objects, or the like. It will be appreciated that interaction by human entity 110₁ with such non-human entities may be performed using devices associated with the non-human entities, as communication between human entity 110₁ and such non-human entities will be performed using communication channels established between the chat application 112₁ running on user device 111₁ of human entity 110₁ and chat applications running on devices associated with the non-human entities or chat applications integrated or associated with programs on devices associated with the non-human entities, respectively. Accordingly, various embodiments discussed herein with respect to human-device interaction between human entity 110₁ and device entity 110₃ and human-program interaction between human entity 110₁ and program entity 110₄ also may be used for other communication interaction types between human entity 110₁ and other types of non-human entities. Namely, in at least some embodiments, other communication interaction types between human entity 110₁ and other types of non-human entities also may be considered to be human-device interaction between human entity 110₁ and a device that is associated with the non-human entity or human-program interaction between human entity 110₁ and a program that is associated with the non-human entity.

The chat-based system 100 supports identification of entities 110 to chat-based core 130 such that the entities 110 are available for association with other entities 110 of chat-based system 100. For example, human entities 110 (illustratively, human entities 110₁ and 110₂, as well as various other human entities) may register with chat-based core 130 (e.g., by establishing an account with chat-based core 130). Similarly, for example, non-human entities 110 (illustratively, device entity 110₃ and program entity 110₄, as well as various other non-human entities) may register with chat-based core 130 or may be registered with chat-based core 130 (e.g., such as where a non-human entity is registered with chat-based core 130 by a human but may then participate in chat-based communications independent of human interaction). In this manner, various entities 110 become discoverable within chat-based system 100 and, thus, associations supporting various communication interactions types may be established between entities 110 as discussed herein.

The chat-based system 100, as discussed above, supports association of entities 110 with human entity 110₁ via chat application 112₁ and, similarly, supports establishment of communication channels 140 between chat application 112₁ of user device 111₁ of human entity 110₁ and chat applications of devices or programs associated with entities 110 that are associated with human entity 110₁ via chat application 112₁. As discussed above, entities 110 that are associated with human entity 110₁ via chat application 112₁ may be associated with human entity 110₁ via a contact list 113₁ of chat application 112₁ for human entity 110₁ (and, similarly, via corresponding contact lists of chat applications of the entities) The association of entities 110 with human entity 110₁ or disassociation of entities 110 from human entity 110₁ (e.g., via addition to or removal of entities 110 from the contact list 113₁ of the chat application 112₁) may be performed manually by human entity 110₁ via chat application 112₁ or automatically by chat-based system 100 based on context information. The establishment of communication channels 140 between chat application 112₁ of user device 111₁ of human entity 110₁ and chat applications of devices or programs associated with entities 110 may be performed, when chat application 112₁ is invoked on user device 111₁, for any entities 110 already associated with human entity 110₁ (e.g., based on entities already included in the contact list 113₁ of the chat application 112₁). For example, chat-based core 130 may be configured to maintain the contact list 113₁ of chat application 112₁ and, based on detection that chat application 112₁ has been invoked on user device 111₁, to provide the contact list 113₁ to chat application 112₁ for use by chat application 112₁ in establishing communication channels 140 between chat application 112₁ of user device 111₁ of human entity 110₁ and entities 110 on the contact list 113₁ of chat application 112₁. The establishment or termination of communication channels 140 between chat application 112₁ of user device 111₁ of human entity 110₁ and chat applications of devices or programs associated with entities 110 also may be performed at any time that chat application 112₁ is running on user device 111₁ (e.g., as non-human entities 110 are dynamically added to and removed from contact list 113₁ of the chat application 112₁ for human entity 110₁ based on context). For example, chat-based core 130 may be configured to detect association of a new entity 110 with human entity 110₁ or disassociation of an existing entity 110 from human entity 110₁, update the contact list 113₁ of chat application 112₁ to add the new entity 110 or remove the existing entity 110, and initiate establishment of a new communication channel 140 for the new entity 110 or termination of the existing communication channel 140 of the existing entity 110.

The chat-based system 100 may be configured to support manual or automated identification of entities 110 available for association with human entity 110₁ and, similarly, may support manual or automated association of identified entities 110 with human entity 110₁ (e.g., via inclusion in contact list 113₁ of chat application 112₁).

The chat-based system 100 may support a search-based entity association capability in which the human entity 110₁ may enter and submit specific search criteria to be used by chat-based core 130 in searching for other entities 110. For example, human entity 110₁ may specify that he or she is searching for printers available at a particular location, restaurants available in a particular geographic area, a human resources program of a company for which he or she works, a banking program of a bank with which he or she maintains an account, a collaborative session related to a particular area of interest, or the like. The chat-based core 130 may use the search criteria to identify a set of potential entities 110 which satisfy the search criteria. The chat-based core 130 may then either (1) propagate search results, including indications of the potential entities 110, toward user device 111₁ for presenting the potential entities 110 to the human entity 110₁ and providing the human entity 110₁ an opportunity to explicitly accept (or not) association of one or more of potential entities 110 with the human entity 110₁ or (2) initiate automatic association of the potential entities 110 with the human entity 110₁ (e.g., via addition of the potential entities 110 to the contact list 113₁ of the chat application 112₁ of human entity 110₁). The manual or automatic association of a potential entity 110 with human entity 110₁ may trigger establishment of a communication channel 140 between chat application 112₁ of user device 111₁ of human entity 110₁ and a chat application of the associated entity 110.

The chat-based system 100 may support a context-based entity association capability in which chat-based core 130 obtains context information and determines whether to modify the entities 110 with which human entity 110₁ is associated (e.g., associating with one or more entities 110 with which human entity 110₁ is not currently associated, disassociating from one or more entities 110 with which human entity 110₁ is currently associated, or a combination thereof). The context information may include context information associated with human entity 110₁, context information associated with a potential or existing entity 110, or the like, as well as various combinations thereof. The context information associated with human entity 110₁ may represent a context of human entity 110₁, a context of user device 111₁, a context of chat application 112₁, any other context which may be associated with human entity 110₁, or the like, as well as various combinations thereof. The context information associated with human entity 110₁ may be a location of the human entity 110₁ or user device 111₁ (e.g., a geographic location, an indoor location, or the like), information communicated via one or more communication channels 140 supported by chat application 112₁ of user device 111₁ for human entity 110₁, an indication of a need or desire of human entity 110₁, or the like, as well as various combinations thereof. The context information associated with a potential or existing entity 110 may represent a context of the potential or existing entity 110, a context of a device associated with the potential or existing entity 110, or the like, as well as various combinations thereof. The context information associated with a potential entity 110 (e.g., being considered for being associated with human entity 110₁) may be a location of the potential entity 110 (e.g., a geographic location, an indoor location, or the like), a capability of the potential entity 110 (e.g., a zoom capability of a camera, a print capability of a printer, or the like), or the like, as well as various combinations thereof. The context information associated with an existing entity 110 (e.g., being considered for being disassociated from human entity 110₁) may be a location of the existing entity (e.g., a geographic location, an indoor location, or the like), a problem associated with the existing entity, or the like, as well as various combinations thereof. The context information may be provided to chat-based core 130, obtained by chat-based core 130 based on monitoring of communications exchanged via one or more communication channels 140 supported by chat application 112₁ of user device 111₁ and traversing chat-based core 130, provided to chat-based core 130 or otherwise obtained by chat-based core 130 from one or more other devices, or the like, as well as various combinations thereof. The management of entities 110 associated with human entity 110₁ may include identifying a set of potential entities 110 based on the context information and either (1) propagating indications of the potential entities 110 (for association with or disassociation from human entity 110₁) toward user device 111₁ for presenting the potential entities 110 to the human entity 110₁ and providing the human entity 110₁ an opportunity to explicitly accept (or not) association of one or more of potential entities 110 with the human entity 110₁ or disassociation of one or more of potential entities 110 from the human entity 110₁ or (2) initiating automatic association/disassociation of the potential entities 110 with/from the human entity 110₁ (e.g., via addition of the potential entities 110 to the contact list 113₁ of the chat application 112₁ of human entity 110₁ in the case of association or removal of the potential entities 110 from the contact list 113₁ of the chat application 112₁ in the case of disassociation). For example, upon detecting that the user device 111₁ of human entity 110₁ has entered a particular geographic area, chat-based core 130 may identify a list of potential entities 110 at or near the geographic area of the user device 111₁ (e.g., a concierge entity at a hotel, a receptionist entity at a dentist office, a printer entity at an office location, or the like). For example, upon detecting particular content in chat-based communication between human entity 110₁ and human entity 110₂, chat-based core 130 may identify, on the basis of the content, a list of potential entities 110 that may be of interest to human entity 110₁ (e.g., upon detecting the word “print” or some variation thereof in a chat session, chat-based core 130 may infer that human entity 110₁ has a need to print a document and, thus, may identify a list of printer entities which may be useful to human entity 110₁). The manual or automatic association of a potential entity 110 with human entity 110₁ may trigger establishment of a communication channel 140 between chat application 112₁ of user device 111₁ of human entity 110₁ and the associated entity 110. As discussed above, it will be appreciated that, although primarily described with respect to use of context information for associating a potential entity 110 with human entity 110₁ and triggering establishment of a communication channel 140 between chat application 112₁ of user device 111₁ of human entity 110₁ and the chat application of the associated entity 110, context information also may be used for disassociating an associated entity 110 from human entity 110₁ (e.g., via removal of the associated entity 110 from contact list 113) and triggering termination of the existing communication channel 140 between the chat application 112₁ of user device 111₁ of human entity 110₁ and the chat application of the existing entity 110. Accordingly, chat-based system 100 may support a dynamic contact list capability whereby associations of human entity 110₁ with other entities 110 may be updated dynamically (including addition and removal) based on context information associated with human entity 110₁ and, similarly, communication channels 140 between chat application 112₁ of user device 111₁ of human entity 110₁ and chat applications of other entities 110 may be controlled dynamically (including establishment and termination). Various embodiments of the dynamic contact list capability may be better understood by way of the following exemplary embodiments and examples.

In at least some embodiments, chat-based system 100 may be configured to, in response to one or more stimuli specified within chat-based system 100, generate a contact list identity (representing an entity 110) in the contact list 113₁ of human entity 110₁, as well as to create an associated communication channel 140 which may be used for communication between human entity 110₁ and entity 110 represented by the generated contact list identity. The stimuli may include device or program state, receipt of a message (e.g., a notification, an event, or the like), or the like, as well as various combinations thereof. The chat-based system 100 (or remote processing capabilities associated with the chat-based system 100) may then support, or even enhance, interaction by human entity 110₁ with the entity 110 that is represented by the generated contact list identity (e.g., facilitating communication between the human entity 110₁ and the entity 110, acting upon messages or information sent from human entity 110₁ to the entity 110, acting upon messages or information sent from entity 110 to human entity 110₁, or the like, as well as various combinations thereof).

In at least some embodiments, for example, dynamic contact list identities may be generated in the contact list 113₁ of human entity 110₁ according to the location of human entity 110₁. For example, a contact list identity named “receptionist” (e.g., a device or program that is configured to provide “receptionist” functions) might appear on contact list 113₁ of human entity 110₁ when human entity 110₁ enters the reception area of a building, such that the chat-based communication interface of chat application 112₁ may be used by human entity 110₁ to send to the “receptionist” entity a request for directions to a particular location in the building, and the chat-based communication interface of the chat application of the “receptionist” entity may be used by the “receptionist” entity to send the requested directions to human entity 110₁ (where the information is exchanged via the communication channel 140 established between the chat application 112₁ and the chat application of the “receptionist” entity). For example, a contact list identity named “concierge” (e.g., a device or program that is configured to provide “concierge” functions) might appear on contact list 113₁ of human entity 110₁ when human entity 110₁ enters a hotel lobby area, such that the chat-based communication interface of chat application 112₁ may be used by human entity 110₁ to send to the “concierge” entity a request for a reservation at a local Italian restaurant, and the chat-based communication interface of the chat application of the “concierge” entity may be used by the “concierge” entity to send to the human entity 110₁ directions to the Italian restaurant at which the “concierge” entity made reservations on behalf of the human entity 110₁ (where the information is exchanged via the communication channel 140 established between the chat application 112₁ and the chat application of the “concierge” entity). For example, a contact list identity named “printer” might appear on contact list 113₁ of human entity 110₁ when human entity 110₁ enters his or her work location, such that the chat-based communication interface of chat application 112₁ may be used by human entity 110₁ to send to the “printer” entity document and a request for the document to be printed, and the chat-based communication interface of the chat application of the “printer” entity may be used by the “printer” entity to send to the human entity 110₁ directions to the location of the printer at which the document was printed for the human entity 110₁ (where the information is exchanged via the communication channel 140 established between the chat application 112₁ and the chat application of the “printer” entity). For example, a contact list identity named “cafeteria” might appear on contact list 113₁ of human entity 110₁ when human entity 110₁ enters a designated location, such that (1) the chat-based communication interface of chat application 112₁ may be used by human entity 110₁ to send a request for a menu, (2) the chat-based communication interface of the chat application of the “cafeteria” entity may be used by the “cafeteria” entity to provide the requested menu to the human entity 110₁, (3) the chat-based communication interface of chat application 112₁ may be used by human entity 110₁ to send an order for food listed on the menu, (4) the chat-based communication interface of the chat application of the “cafeteria” entity may be used by the “cafeteria” entity to request payment for the food ordered by human entity 110₁, (5) the chat-based communication interface of chat application 112₁ may be used by human entity 110₁ to provide payment for the food ordered by human entity 110₁, and (6) the chat-based communication interface of the chat application of the “cafeteria” entity may be used by the “cafeteria” entity to direct the human entity 110₁ to a location where the food may be picked up (where the information is exchanged via the communication channel 140 established between the chat application 112₁ and the chat application of the “cafeteria” entity).

In at least some embodiments, for example, dynamic contact list identities may be generated in the contact list 113₁ of human entity 110₁ according to association of human entity 110₁ with a process. For example, a contact list identity named “voice conference” might appear on contact list 113₁ of human entity 110₁ when human entity 110₁ joins the voice conference, such that a communication channel 140 established between the chat application 112₁ and the chat application of the “voice conference” entity (e.g., a device or program that is associated with the voice conference) may be used by the human entity 110₁ and the “voice conference” entity to perform various functions within the context of the voice conference (e.g., to request and control sending of an invite for an additional party to join the voice conference, to request a copy of the slides being discussed and have the requested slides be retrieved from a server and delivered to the chat application 112₁ for presentation to human entity 110₁, or the like). For example, a set of contact list identities associated with functions supporting a multi-party remote collaboration session (e.g., “attendance”, “minutes”, “slides”, “video” or the like, which, for example, might be organized under a higher-level entity called “collaborative support”) might appear on contact list 113₁ of human entity 110₁ when human entity 110₁ joins the multi-party remote collaboration session, such that communication channels 140 established between the chat application 112₁ and chat applications of the “collaborative support” entities (e.g., devices or programs associated with the multi-party remote collaboration session) may be used by the human entity 110₁ and the “collaborative support” entities to perform various functions within the context of the multi-party remote collaboration session (e.g., to request a copy of the slides being discussed and have the requested slides be retrieved from a server and delivered to the chat application 112₁ for presentation to human entity 110₁, to request a video feed of a physical location where parties to the multi-party remote collaboration session are located and have the video feed delivered to the chat application 112₁ for presentation to human entity 110₁, or the like).

In at least some embodiments, chat-based system 100 may be configured to, in response to one or more stimuli specified within chat-based system 100, remove an existing contact list identity (representing an entity 110 with which human entity 110₁ is associated) from the contact list 113₁ of human entity 110₁, as well as to terminate an existing communication channel 140 previously established for communication between human entity 110₁ and the entity 110 represented by the existing contact list identity. The stimuli may include device or program state, receipt of a message (e.g., a notification, an event, or the like), or the like, as well as various combinations thereof. This embodiment may be better understood by further considering the examples discussed above in conjunction with dynamic generation of contact list identities. For example, the “receptionist” entity may be removed from the contact list 113₁ based on a determination that the human entity 110₁ has left the building, the “concierge” entity may be removed from the contact list 113₁ based on a determination that the human entity 110₁ has left the lobby area of the hotel, the “printer” entity may be removed from the contact list 113₁ based on a determination that the human entity 110₁ has left the building, the “cafeteria” entity may be removed from the contact list 113₁ based on a determination that the human entity 110₁ has left the building, the “voice conference” entity may be removed from the contact list 113₁ based on a determination that the human entity 110₁ has left the voice conference, the “collaborative support” entities may be removed from the contact list 113₁ based on a determination that the human entity 110₁ has left the multi-party remote collaboration session, and so forth.

In at least some embodiments, chat-based system 100 may be configured to support associations between contacts of an entity 110 (e.g., between contacts included in the contact list 113₁ of chat application 112₁ of human entity 110₁). The associations between contacts of human entity 110₁ may be established or removed one or more of manually responsive to input from human entity 110₁, automatically by chat-based core 130 or entity representatives 120 (e.g., based on knowledge or inference of relationships or interfaces, or knowledge or inference of lack of relationships or interfaces, between the contacts), or the like, as well as various combinations thereof. For example, a “home” contact may be associated with, and configured to act as an interface to, a collection of more specialized contacts (e.g., a “computer” contact, an “entertainment system” contact, a “smart device” contact, or the like). For example, a “work” contact may be associated with, and configured to act as an interface to, a collection of more specialized contacts (e.g., a “printer” contact, a “copier” contact, a “fax machine” contact, a “cafeteria” contact, a “human resources” contact, one or more co-worker contacts, or the like). For example, a “car” contact may be associated with, and configured to act as an interface to, a collection of more specialized contacts (e.g., an “engine” contact, “a climate control” contact, a “radio” contact, or the like). The associations between contacts of human entity 110₁ may be used in various ways to support interactions between human entity 110₁ and various other entities 110.

The chat-based system 100 may support a single login authentication capability for human entity 110₁ via the chat application 112₁, whereby human entity 110 is only required to login chat application 112₁ in order to access other entities 110 associated with human entity 110₁. For example, when human entity 110₁ invokes the chat application 112₁, human entity 110₁ may be prompted to enter authentication information (e.g., login and password) which may then be sent to chat-based core 130 for use in authenticating the human entity 110₁ (namely, for determining whether human entity 110₁ is permitted to access chat application 112₁). Here, authentication of the human entity 110₁ to access other entities 110 may have been previously established, or may be performed by chat-based core 130 on behalf of human entity 110₁ responsive to authentication of human entity 110₁ to access chat application 112₁ (e.g., where chat-based core 130 initiates authentication with one or more of the entities 110 included in the contact list 113₁ associated with human entity 110₁). In either case, human entity 110₁ is authenticated to access the other entities 110 automatically, without requiring the human entity 110₁ to enter additional authentication information for each of the other entities 110. In other words, the authentication procedures of the chat application 112₁ allow interaction with various devices (e.g., device entity 110₃) and programs (e.g., program entity 110₄). In this manner, authentication by the human entity 110₁ for multiple other entities 110 (e.g., devices, programs, or the like) becomes seamless for human entity 110₁.

The chat application 112₁ of user device 111₁ is configured to provide various function supporting human-to-human interactions (e.g., between human entity 110₁ and human entity 110₂ via communication channel 140₁) as well as other communication interaction types, including human-device interactions (e.g., between human entity 110₁ and device entity 110₃ via communication channel 140₂) and human-program interactions (e.g., between human entity 110₁ and program entity 110₄ via communication channel 140₃). The functions typically supported by a chat application in enabling human-to-human interactions are understood and thus, are not repeated herein. It will be appreciated that at least some such functions typically supported by a chat application in enabling human-to-human interactions may be used, or adapted for use, in supporting other communication interaction types discussed herein.

The chat application 112₁ of user device 111₁ may be configured to provide one or more mechanisms via which human entity 110₁ may identify non-human entities 110 with which human entity 110₁ has associations and, thus, with which the chat application 112₁ has corresponding communication channels 140, respectively. For example, the chat application 112₁ may be configured such that human entity 110₁ may identify associated non-human entities 110 via one or more menus or other controls available from chat application 112₁. For example, the chat application 112₁ may be configured such that associated non-human entities 110 are represented within, and, thus, may be identified from, the contact list 113₁ of the chat application 112₁ (e.g., using an entity identifier of the non-human entity 110, similar to the manner in which human contacts (or “buddies”) of human entity 110₁ might be represented within contact list 113). The contact list 113₁ may be a common contact list including both human entities 110 and non-human entities 110 with which human entity 110₁ is associated (e.g., arranged alphabetically or based on status irrespective of whether the contact is a human entity 110 or a non-human entity 110, organized into subgroups based on the contacts being human entities 110 or non-human entities 110 and then arranged alphabetically or based on status, or the like), a separate contact list including only non-human entities 110 with which human entity 110₁ is associated (e.g., where human entities 110 with which human entity 110₁ is associated may be maintained in a separate contact list), or the like. In the case of dynamic addition or removal of non-human entities 110, the contact list 113₁ may be automatically updated to display or not display non-human entities 110 as the non-human entities 110 are added or removed, respectively (in other words, non-human entities 110 may automatically appear on and disappear from contact list 113₁ as the non-human entities 110 are added or removed, respectively). The chat application 112₁ may be configured to provide other mechanisms via which human entity 110₁ may identify non-human entities 110 with which human entity 110₁ has associations.

The chat application 112₁ of user device 111₁ may be configured to provide one or more chat-based communication interfaces via which human entity 110₁ may interact with non-human entities 110 with which human entity 110₁ has associations. The manner in which human entity 110₁ uses a chat-based communication interface of chat application 112₁ to initiate communication with an associated non-human entity 110 may depend on the manner in which human entity 110₁ identifies the associated non-human entity 110 via chat application 112₁ (e.g., via one or more menu or other control selections, from displayed contact list 113, or the like). For example, human entity 110₁ may select the associated non-human entity 110 from a drop-down menu, select the associated non-human entity 110 from contact list 113₁ where the associated non-human entity 110 is displayed in the contact list 113, or the like. For example, selection of the associated non-human entity 110 may trigger opening of a window or dialog box via which the human entity 110 may initiate communications with the associated non-human entity 110 (e.g., typing text, attaching content or the like), may trigger opening of a menu via which the human entity 110 may initiate communications with the associated non-human entity 110, or the like, as well as various combinations thereof. The manner in which human entity 110₁ is made aware of a communication from an associated non-human entity 110 via a chat-based communication interface of chat application 112₁ may depend on the configuration of the chat application 112₁. For example, notification of receipt of the communication from the associated non-human entity 110 may be presented to the human entity 110₁ by the chat application 112₁ via one or more interfaces of chat application 112₁, by triggering opening of one or more windows outside of the context of chat application 112₁, via invocation of one or more programs on user device 111₁, or the like, as well as various combinations thereof. For example, notification of receipt of the communication from the associated non-human entity 110 may be presented to the human entity 110₁ by the chat application 112₁ via a presentation interface of user device 111₁ (e.g., such that the human entity 110₁ may then access the communication), the communication from the associated non-human entity 110 to the human entity 110₁ may be presented to the human entity 110₁ by the chat application 112₁ (e.g., similar presentation of chat messages from human entities in typical chat applications), information provided from the associated non-human entity 110 to human entity 110₁ may be presented to the human entity 110₁ via invocation of one or more associated programs or applications on user device 111₁ (e.g., launching a word processing application for presentation of a text document provided in the communication from the associated non-human entity 110, launching an audio player for playout of audio content provided in the communication from the associated non-human entity 110, launching a video player for playout of video content provided in the communication from the associated non-human entity 110, or the like), or the like, as well as various combinations thereof.

The chat applications 112₃ and 112₄ may be configured to operate in a manner similar to chat application 112₁, although, as discussed above, it is expected that, rather than being displayed (such as chat applications 112₁ and 112₂), chat applications 112₃ and 112₄ may run on device entity 110₃ and device 111₄, respectively. The chat-based communication interfaces of chat applications 112₃ and 112₄ may include any suitable software and/or hardware based interfaces which enable interaction between the chat applications 112₃ and 112₄ and software and/or hardware components or elements of the device entity 110₃ and the device 111₄ on which chat applications 112₃ and 112₄ are executing, respectively, as discussed above.

The entity representatives 120 associated with entities 110 are configured to provide various functions, at least some of which have been discussed above. For example, an entity representative 120 associated with a non-human entity 110 may provide or support one or more of registration functions for enabling the non-human entity 110 to register with chat-based core 130 (and, thus, to be identified by and associated with human entity 110₁), communication channel control functions for establishing and maintaining one or more communication channels 140 for chat-based communication between the non-human entity 110 and one or more other entities 110 (illustratively, communication channel 140₂ for chat-based communication with human entity 110₁, as well as any other suitable communication channels 140), communication control functions for controlling communication between the non-human entity 110 and one or more other entities 110 via one or more communication channels 140, translation functions for translating messages and information between the format(s) supported by the non-human entity 110 and the format(s) supported by one or more other entities 110 with which non-human entity 110 may communicate via one or more communication channels 140, enhanced processing functions for supporting enhanced processing which may be provided by the non-human entity 110 based on communication between the non-human entity 110 and one or more other entities 110 via one or more communication channels 140, or the like, as well as various combinations thereof. The translation functions may include natural language recognition capabilities for allowing chat-based communications to be translated between human-understandable text and formats supported by non-human entities 110. Similarly, for example, an entity representative 120 associated with a human entity 110 (illustratively, entity representative 120₁ associated with human entity 110₁) may be configured to provide similar functions for supporting communications between the human entity 110 and one or more non-human entities 110. The entity representatives 120 may be configured to support various types of activities and services which may be provided based on communication between entities 110 via communication channels 140. The entity representatives 120 also may be configured to include various modules or provide various functions primarily depicted and described herein as being performed by chat applications 112 operating on endpoint devices (e.g., providing a differently or more distributed deployment of chat applications 112).

The chat-based core 130 is configured to provide various functions, at least some of which have been discussed above. For example, chat-based core 130 may provide or support one or more of registration functions for enabling the entities 110 to register with chat-based core 130 (and, thus, to be identified by and associated with other entities 110), communication channel control functions for establishing and maintaining communication channels 140 between chat applications 112 of entities 110, communication control functions for controlling communication between entities 110 via associated communication channels 140, translation functions for translating messages and information between different formats supported by different entities 110, enhanced processing functions for supporting enhanced processing which may be provided based on communication between entities 110 via communication channels 140, or the like, as well as various combinations thereof. The translation functions may include natural language recognition capabilities for allowing chat communications to be translated between human-understandable text and formats supported by non-human entities 110. The chat-based core 130 may be configured to support various types of activities and services which may be provided based on communication between entities 110 via communication channels 140. The chat-based core 130 also may be configured to include various modules or provide various functions primarily depicted and described herein as being performed by chat applications 112 operating on endpoint devices (e.g., providing a differently or more distributed deployment of chat applications 112).

The communication channels 140 established between chat application 112₁ of human entity 110₁ and chat applications 112 of other entities 110 support chat-based communications between human entity 110₁ and the other entities 110, respectively. The communication channels 140 may be established and maintained using chat-based functions. The communication channels 140 may be accessed via chat-based communication interfaces supported by the chat applications 112 between which the communication channels 140 are established. The communication channels 140 support various communication interaction types as discussed above. The communication channels 140 support chat-based or chat-like communication between human entity 110₁ and other entities 110. The communication channels 140 provide communication paths for various types of messages and information which may be exchanged between entities 110 (e.g., requests and responses, commands and responses, event notifications, content delivery, or the like, as well as any other types of messages or information which may be propagated via the communication channels 140). The communication channels 140 may support various types of activities and services which may be provided based on communication between human entity 110₁ and other entities 110 via communication channels 140. The communication channels 140 may be supported using any suitable underlying communication networks (e.g., wireline networks, wireless networks, or the like) which, it will be appreciated, may depend on the context within which the communication channels 140 are established. As indicated above, although the communication channels 140 are primarily depicted and described as being established between the chat application 112₁ of user device 111₁ of human entity 110₁ and the chat applications 112 of other entities 110, the communication channels 140 also may be considered to be established between the user device 111₁ of human entity 110₁ and devices hosting the chat applications 112 of the other entities 110, between the user device 111₁ of human entity 110₁ and programs associated with the chat applications 112 of the other entities 110, or the like.

The chat-based system 100 may be configured to support enhanced processing for communications exchanged via communication channels 140. As noted above, enhanced processing for communications exchanged via communication channel 140 may be provided by one or more of the entities 110 participating in the communication, one or more entity representatives 120 of the one or more of the entities 110 participating in the communication, chat-based core 130, or a combination thereof. For example, enhanced processing for communications exchanged via a given communication channel 140 may include time-based acceleration or deceleration of actions based on context (e.g., delaying printing of a document by a printer until the person is detected as being at or near the location of the printer, accelerating processing of a food order at a restaurant based on a determination that the person has arrived at the restaurant ahead of schedule, or the like), initiating or terminating one or more entity associations (e.g., adding a new entity to a contact list or removing an entity from a contact list) based on information exchanged via the given communication channel 140 (e.g., automatically initiating addition of a home security control entity for securing a home of a user based on a chat message indicative that the user is away from home, automatically initiating removal of a printer entity for a work printer of a user based on a chat message indicative that the user is working from home, or the like), initiating one or more messages to one or more existing or new entities via one or more existing or new communication channels based on information exchanged via the given communication channel 140 (e.g., automatically initiating a message to a taxi scheduling entity for scheduling a taxi based on detection that a concierge entity has made a reservation with a restaurant entity, automatically initiating a message to a credit score entity based on detection that a banking entity requires credit scope information, or the like), automatically performing one or more actions outside of the context of the chat application based on context information determined from communications exchanged via the given communication channel 140 (e.g., initiating or terminating a phone call, launching or terminating a program, or the like), or the like, as well as various combinations thereof.

The chat-based system 100 may be configured to support higher level system enhancements for chat-based system 100. For example, chat-based system 100 may be configured to generate various contexts for various chat sessions and to use the context information to control execution of chat-based system 100 (e.g., context information about past interactions among chat participants via chat-based system 100 can be used by chat-based system 100 to fine-tune various aspects of chat-based system 100, such as the form of interaction between chat participants, presentation of data to chat participants, or the like, as well as various combinations thereof).

The chat-based system 100 may be configured to support data analytics functions. In at least some embodiments, data from one or more entities 110 may be analyzed to develop a model or representation of the context in which a chat(s) occurs. The data may include chat messages, data other than chat-based data, or a combination thereof. The data analytics may be performed locally (e.g., using one or more local modules), remotely (e.g., using one or more remote modules), or a combination thereof. The context may then be utilized locally (e.g., by one or more local modules), remotely (e.g., by one or more remote modules), or a combination thereof. The context may be used for various purposes (e.g., to handle chat messages, to act in response to chat messages, or the like, as well as various combinations thereof). The data analytics functions may be provided by chat-based core 130, entity representatives 120, entities 110, or the like, as well as various combinations thereof. The use of context in this manner permits integration of data analytics into a wide range of communication functions and behaviors.

As discussed above, while chat-based system 100 is primarily depicted and described with respect to supporting multiple communication interaction types for a human entity, chat-based system 100 may be configured to support communication between non-human entities, where the non-human entities may include devices, programs, processes, organizations, or the like. An example is depicted in FIG. 1, where a communication channel 141 is established between chat application 112₃ of device entity 110₃ and chat application 112₄ of program entity 110₄. The establishment and use of communication channel 141 may be similar to establishment and use of communication channels 140. For example, where device entity 110₃ is a printer located in an office of an employee of a company and program entity 110₄ is a human resources program of the company, the human resources program may propagate a benefits agreement that needs to be signed by the employee to the printer, via the communication channel 141, such that the benefits agreement is automatically printed and readily available for signature by the employee. For example, where device entity 110₃ is a security camera and program entity 110₄ is a security monitoring program, the security monitoring program may propagate a reconfiguration message to the security camera, via the communication channel 141, such that the security camera is automatically reconfigured based on the needs of the security program. For example, where device entity 110₃ is a content server and program entity 110₄ is a personal content scheduling program of a user that is running on a device (e.g., computer, digital video recorder, or the like), the personal content scheduling program may propagate a content request message to the content server via the communication channel 141 in order to request retrieval of a content item predicted by the personal content scheduling program to be of interest to the user, and the content server may provide the requested content item to the personal content scheduling program for storage on the device on which the personal content scheduling program is running. It will be appreciated that, although primarily depicted and described with respect to a specific communication interaction type between specific types of non-human entities (namely, device-program communications), chat-based system 100 may be configured to support various other communication interaction types between various other combinations of non-human entities (e.g., device-device communications between devices, program-program communications between programs, device-process communications between a device and a process, program-process communications between a program and a process, process-process communications, and so forth). For example, a power monitoring entity could use a chat-based communication channel to ask a power meter for a current reading. For example, a concierge entity could use a chat-based communication channel to ask a restaurant entity for a reservation. It will be appreciated that the foregoing examples are merely a few of the ways in which chat-based communication between multiple non-human entities may be used.

It will be appreciated that, although omitted from FIG. 1 for purposes of clarity, each chat application 112 may be implemented using any suitable concentration or distribution of functions. For example, chat applications 112 depicted in FIG. 1 may simply be chat application clients and other modules or functions of the associated chat application may be implemented in other locations (e.g., on entity representatives 120, on chat-based core 130). Various other arrangements of the functions of chat applications 112 within chat-based system 100 are contemplated.

It will be appreciated that, although omitted from FIG. 1 for purposes of clarity, each entity representative 120 may be implemented using any suitable concentration or distribution of functions (e.g., providing the functions of an entity representative 120 on one or more devices associated with the entity representative 120, providing the functions of an entity representative 120 on one or more network devices, distributing the functions of an entity representative 120 across one or more devices associated with the entity representative 120 and one or more network devices, or the like, as well as various combinations thereof).

It will be appreciated that, although omitted from FIG. 1 for purposes of clarity, chat-based core 130 may be implemented in any suitable manner (e.g., on one or more dedicated servers, using one or more sets of virtual resources hosted within one or more networks or datacenters, or the like, as well as various combinations thereof).

It will be appreciated that, although primarily depicted and described with respect to embodiments in which chat application 112₁ is configured to support human-to-human communication as well as other communication interaction types, in at least some embodiments the chat application 112₁ may be configured only for interaction between human entity 110₁ and non-human entities 110. In other words, the chat application 112₁ may be dedicated for supporting various communication interaction types involving communication between human entity 110₁ and non-human entities 110, thereby providing one or more of a device access and use capability, a program access and use capability, or the like, as well as various combinations thereof.

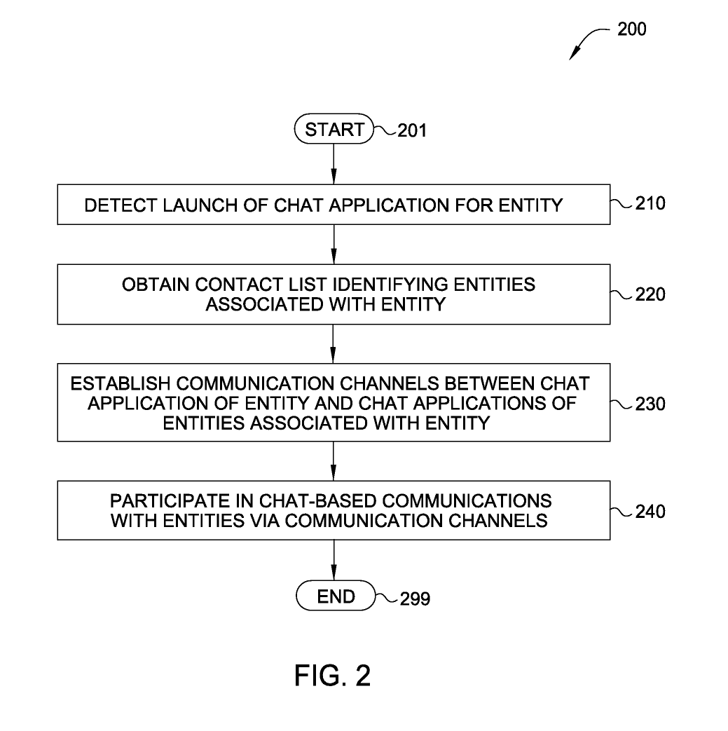

FIG. 2 depicts an exemplary embodiment of a method for supporting chat-based communications for multiple communication interaction types. It will be appreciated that, although primarily depicted and described from the perspective of an entity (or a device supporting communications by the entity), the execution of at least a portion of the steps of method 200 also may include various actions which may be performed by other elements (e.g., other entities, entity representatives of the entities, a chat-based core, or the like, as well as various combinations thereof). It will be appreciated that, although primarily depicted and described as being performed serially, at least a portion of the steps of method 200 may be performed contemporaneously or in a different order than as presented in FIG. 2. At step 201, method 200 begins. At step 210, the launch of a chat application for an entity is detected. The entity may be a human entity or a non-human entity. At step 220, a contact list, identifying entities associated with the entity, is obtained. The entities may include one or more human entities, one or more non-human entities, or combinations thereof. At step 230, communication channels are established between the chat application of the entity and chat applications of the entities identified in the contact list. At step 240, the entity participates in chat-based communications with entities identified in the contact list via the communication channels established between the chat application of the entity and the chat applications of the entities identified in the contact list. At step 299, method 200 ends. It will be appreciated that various functions depicted and described within the context of FIG. 1 may be provided within the context of method 200 of FIG. 2.

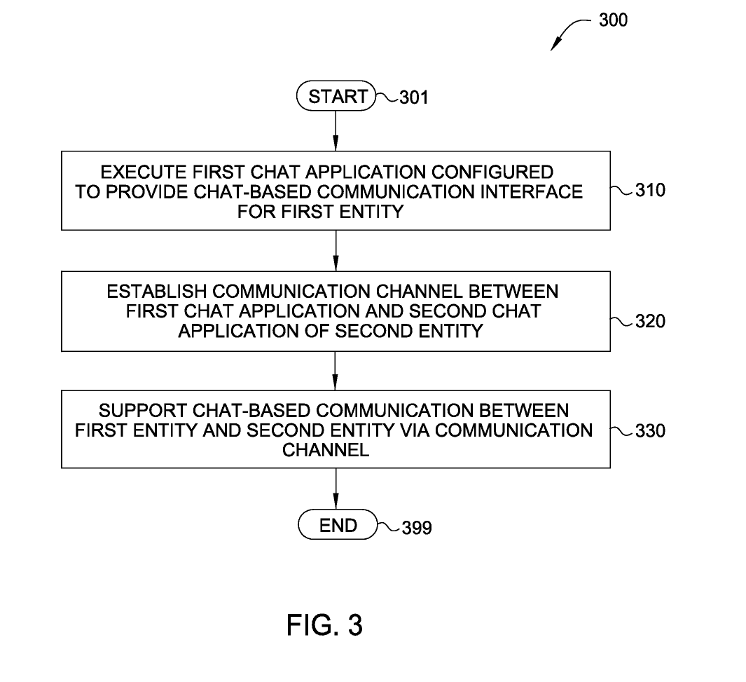

FIG. 3 depicts an exemplary embodiment of a method for supporting chat-based communications. It will be appreciated that, although primarily depicted and described from the perspective of an entity (or a device supporting communications by the entity), the execution of at least a portion of the steps of method 300 also may include various actions which may be performed by other elements (e.g., other entities, entity representatives of the entities, a chat-based core, or the like, as well as various combinations thereof). It will be appreciated that, although primarily depicted and described as being performed serially, at least a portion of the steps of method 300 may be performed contemporaneously or in a different order than as presented in FIG. 3. At step 301, method 300 begins. At step 310, a first chat application configured to provide a chat-based communication interface for a first entity is executed. The first chat application configured to provide the chat-based communication interface for the first entity also may be said to be invoked, or may be said to running or active. At step 320, a communication channel is established between the first chat application and a second chat application of a second entity. The second entity is a non-human entity. At step 330, chat-based communication between the first entity and the second entity is supported via the communication channel. At step 399, method 300 ends. The communication channel may be established based on a determination that the second entity is associated with the first chat application. The determination that the second entity is associated with the first chat application may be based on a determination that the second entity is included within a contact list of the first chat application. The determination that the second entity is associated with the first chat application may be performed responsive to invocation of the first chat application. The determination that the second entity is associated with the first chat application may be a dynamic detection of association of the second entity with the first chat application while the first chat application is running. The dynamic association of the second entity with the first chat application while the first chat application is running may be performed based on at least one of context information associated with the first entity or context information associated with the second entity. The context information associated with the first entity may include at least one of a location of the first entity, information from a chat-based communication of the first entity, a detected need of the first entity, or the like. The context information associated with the second entity may include at least one of a location of the second entity, a capability of the second entity, or the like. The support of chat-based communication between the first entity and the second entity via the communication channel may include propagating, toward the second chat application of the second entity via the communication channel, information entered by the first entity via the chat-based communication interface of the first chat application. The support of chat-based communication between the first entity and the second entity via the communication channel may include receiving information entered by the first entity via the chat-based communication interface of the first chat application, processing the information to convert the information into modified information (e.g., translating the information from one format to another, supplementing the information with additional information, or the like, as well as various combinations thereof), and propagating the modified information toward the second entity via the communication channel. The support of chat-based communication between the first entity and the second entity via the communication channel may include receiving information from the second entity via the communication channel and initiating propagation or presentation of the information to the first entity. The initiation of presentation of the information to the first entity may include at least one of initiating presentation of at least a portion of the information via the chat-based communication interface of the first chat application, initiating presentation of at least a portion of the information via an interface other than the chat-based communication interface of the first chat application, or the like. The support of chat-based communication between the first entity and the second entity via the communication channel may include receiving information from the second entity via the communication channel, processing the information to convert the information into modified information (e.g., translating the information from one format to another, supplementing the information with additional information, or the like, as well as various combinations thereof), and propagating the modified information toward the first entity. The communication channel may be terminated based on a determination that the second entity is no longer associated with the first chat application. The first entity may be a human entity or a non-human entity. The non-human entity may be a device, a program, or another non-human entity. The non-human entity may include a process or an organization, where the communication channel is established with a device or program associated with the process or the organization. It will be appreciated that various functions depicted and described within the context of FIG. 1 may be provided within the context of method 300 of FIG. 3.

In at least some embodiments, a capability for providing user interface encapsulation within a chat-based system (e.g., chat-based system 100 of FIG. 1 or any other suitable type of chat-based system) is supported. Various embodiments of the capability for providing user interface encapsulation within a chat-based system may extend a conventional chat-based system to create a framework and communication paradigm that supports integration of a chat application and one or more other applications (e.g., a software control application, a device control application, a gaming application, a chat buddy as discussed hereinabove, or the like, as well as various combinations thereof). Various embodiments of the capability for providing user interface encapsulation within a chat-based system may enable a chat application (e.g., a chat session) to serve as a context for interaction by a chat participant with multiple applications (e.g., the chat application itself and one or more other applications) while supporting seamless transition by the chat participant between the applications within the context of the chat application. Various embodiments of the capability for providing user interface encapsulation within a chat-based system provide mechanisms for creating a user interface responsive to a user request or other trigger event. Various embodiments of the capability for providing user interface encapsulation within a chat-based system enable expansion of chat-based communication paradigms to support dynamic creation of a vast range of generalized or specialized user interfaces.

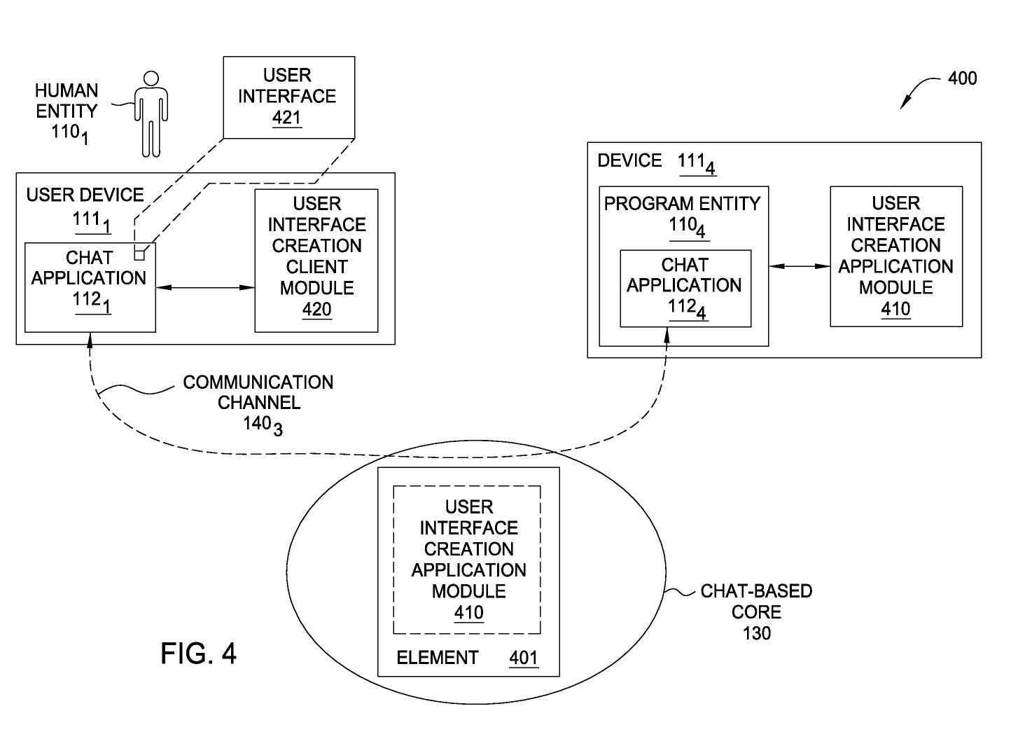

Various embodiments of the capability for providing user interface encapsulation within a chat-based system may enable a participant of a chat session to interact with one or more user interfaces of one or more applications within the context of that chat session (e.g., within one or more windows of the chat session, within one or more messages of the chat session, or the like), thereby obviating the need for the chat participant to interact with the chat session and the one or more user interfaces of the one or more applications separately (which, it is expected, would not provide a seamless user experience for the chat participant). Various embodiments of the capability for providing user interface encapsulation within a chat-based system may enable a chat session (e.g., one or more chat windows within a chat session), in addition to or in place of supporting traditional exchanges of text messages and attachments (e.g., photos, files, or the like), to be used as an interface for one or more applications. Various embodiments of the capability for providing user interface encapsulation within a chat-based system, by supporting encapsulation of one or more user interfaces of one or more applications within a chat session, may enable integration of the chat session interface and the one or more user interfaces of the one or more applications (which may be used by the chat participant or other users for user interactions with the one or more other applications). Various embodiments of the capability for providing user interface encapsulation within a chat-based system, by supporting encapsulation of one or more user interfaces of one or more applications within a chat session, may support an encompassing environment for the one or more other applications (whereas, in the absence of the capability for providing user interface encapsulation within a chat-based system, a user would be required to access and interact with the one or more user interfaces of the one or more applications outside of the context of the chat session). Various embodiments of the capability for providing user interface encapsulation within a chat-based system, by supporting encapsulation of one or more user interfaces of one or more applications within a chat session, may obviate the need for a user to interact with the chat session and the one or more user interfaces of the one or more applications separately. Various embodiments of the capability for providing user interface encapsulation within a chat-based system, by supporting encapsulation of one or more user interfaces of one or more applications within a chat session, may be said to provide a “user interface in a bubble” capability, whereby a chat message of a chat session (which is typically displayed as a “text bubble”) may be configured to support one or more user interfaces of one or more applications. Various embodiments of the capability for providing user interface encapsulation within a chat-based system may provide improved mechanisms for enabling people to interact with various entities (e.g., humans, devices, specialized remote objects, computer programs, or the like). Various embodiments of the capability for providing user interface encapsulation within a chat-based system may obviate the need for use of web browsers as a mechanism for use of digital networks. These and various other embodiments and advantages of the capability for providing user interface encapsulation within a chat-based system may be further understood by way of reference to an exemplary embodiment for providing user interface encapsulation within a chat application of a chat-based system, as depicted in FIG. 4.

FIG. 4 depicts an exemplary embodiment for supporting user interface encapsulation within a chat session supported by the exemplary chat-based system of FIG. 1. As depicted in FIG. 4, exemplary chat-based system 400, which includes components of chat-based system 100 of FIG. 1, is configured to support a user interface encapsulation capability. As further depicted in FIG. 4, the user interface encapsulation capability is being provided at user device 111₁ for human entity 110₁ based on chat-based communication between human entity 110₁ at user device 111₁ and program entity 110₄ of device 111₄ via the chat-based core 130 (illustratively, using communication channel 140₃ supporting exchanging of chat-based messages between chat application 112₁ of user device 111₁ and chat application 112₄ of program entity 110₄ of device 111₄). As further depicted in FIG. 4, the user interface encapsulation capability is provided using a user interface creation application module 410 (which, as illustrated in FIG. 4, may reside on one or both of device 111₄ or an element 401 of chat-based core 130) and a user interface creation client module 420 (which, as further illustrated in FIG. 4, may be implemented on user device 111₁).

The user interface creation application module 410 is configured to determine that a user interface is to be created within chat application 112₁ of user device 111₁ (e.g., within a chat session supported by chat application 112₁ of user device 111₁, such as within a chat interface of chat application 112₁ supporting a chat session, within a chat message of a chat session supported by chat application 112₁, or the like) and to propagate, toward user device 111₁, information configured for use by the user device 111₁ to create the user interface within the chat application 112₁.

The user interface creation application module 410, as noted above, is configured to determine that a user interface is to be created within chat application 112₁ of user device 111₁. The determination by the user interface creation application module 410 that the user interface is to be created within chat application 112₁ of user device 111₁ also or alternatively may be one or more of a determination that a user interface is to be created within a chat session of chat application 112₁, a determination that a user interface is to be created for human entity 110₁ using chat application 112₁, or the like. The determination by the user interface creation application module 410 that the user interface is to be created may be based on a trigger condition. The trigger condition may be related to the chat session (e.g., receipt of a chat message from chat application 112₁ of user device 111₁ or the like) or independent of the chat session (e.g., a scheduled event or the like). For example, where user interface creation application module 410 is running on device 111₄, device 111₄ may be configured to determine that a user interface is to be created within a chat session of chat application 112₁ based on receipt of a chat message from chat application 112₁ via a chat session between chat application 112₁ and chat application 112₄. For example, where user interface creation application module 410 is running on element 401 of chat-based core 130, the element 401 of chat-based core 130 may receive or intercept a chat message sent from chat application 112₁ to chat application 112₄ via a chat session between chat application 112₁ and chat application 112₄ and determine, based on the chat message, that a user interface is to be created within a chat session of chat application 112₁ based on receipt of a chat message.

The user interface creation application module 410, as noted above, is configured to propagate information configured for use by the user device 111₁ to create the user interface within the chat application 112₁. The information configured for use by the user device 111₁ to create the user interface within the chat application 112₁ may include one or more of executable code for execution by the user device 111₁ to create the user interface within the chat application 112₁, data configured for use by the user device 111₁ to create the user interface within the chat application 112₁, or the like, as well as various combinations thereof. The information configured for use by user device 111₁ to create the user interface within the chat application 112₁ may be propagated to user device 111₁ in various ways (e.g., within one or more chat messages, within one or more non-cat-based messages, or the like, as well as various combinations thereof). For example, where user interface creation application module 410 is running on device 111₄, device 111₄ may be configured to propagate the information configured for use by user device 111₁ to create the user interface within one or more chat messages sent via the chat session between chat application 112₄ on device 111₄ and chat application 112₁ on user device 111₁. For example, where user interface creation application module 410 is running on element 401 of chat-based core 130, element 401 of chat-based core 130 may be configured to propagate the information configured for use by user device 111₁ to create the user interface within one or more chat messages sent via the chat session between chat application 112₄ on device 111₄ and chat application 112₁ on user device 111₁ where element 401 of chat-based core 130 is also a chat participant of that chat session, within one or more chat messages sent via an existing or new chat session between element 401 of chat-based core 130 and chat application 112₁ on user device 111₁, or the like, as well as various combinations thereof.

The user interface creation client module 420 is configured to receive information configured for use by the user device 111₁ to create a user interface within chat application 112₁ of user device 111₁ (e.g., within a chat session supported by chat application 112₁ of user device 111₁, such as within a chat interface of chat application 112₁ supporting a chat session, within a chat message of a chat session supported by chat application 112₁, or the like) and to initiate creation of the user interface within chat application 112₁ of user device 111₁ based on the information configured for use by the user device 111₁ to create a user interface within chat application 112₁ of user device 111₁.

The user interface creation client module 420, as discussed above, is configured to receive information configured for use by the user device 111₁ to create a user interface within chat application 112₁ of user device 111₁ (e.g., within the chat interface of chat application 112₁). The information configured for use by user device 111₁ to create a user interface within chat application 112₁ of user device 111₁, as discussed above with respect to user interface creation application module 410, may include one or more of executable code, data, or the like, as well as various combinations thereof. The information configured for use by user device 111₁ to create a user interface within chat application 112₁ of user device 111₁, as discussed above with respect to user interface creation application module 410, may be received in various ways (e.g., in one or more chat-based messages, in one or more non-chat-based messages propagated outside of the chat-based system, or the like, as well as various combinations thereof).

The user interface creation client module 420, as discussed above, is configured to initiate creation of the user interface within chat application 112₁ of user device 111₁ based on the information configured for use by the user device 111₁ to create a user interface within chat application 112₁ of user device 111₁. The user interface creation client module 420 may be configured such that, when the information configured for use by the user device 111₁ to create a user interface within chat application 112₁ of user device 111₁ includes executable code, user interface creation client module 420 executes the executable code to create the user interface. The user interface creation client module 420 may be configured such that, when the information configured for use by the user device 111₁ to create a user interface within chat application 112₁ of user device 111₁ includes data, user interface creation client module 420 executes executable code (e.g., executable code received as part of the information configured for use by the user device 111₁ to create the user interface, executable code that is already available on user device 111₁ and which is not received as part of the information configured for use by the user device 111₁ to create the user interface, or the like, as well as various combinations thereof) which uses the data to create user interface.

The user interface creation client module 420, as discussed above, creates the user interface within chat application 112₁ of user device 111₁ based on the information configured for use by the user device 111₁ to create a user interface within chat application 112₁ of user device 111₁. This is depicted in FIG. 4 as user interface 421.

The user interface 421 may be created within a chat interface of chat application 112₁ of user device 111₁. The user interface 421 may be created using a single message of a single window of a chat session, using multiple messages of a single window of a chat session, using multiple windows of a chat session, using multiple windows of multiple chat sessions, or the like, as well as various combinations thereof. The user interface 421 may be created within one or more existing windows which may display chat messages of one or more chat sessions, by spawning one or more new windows which may or may not display chat messages of one or more chat sessions, or the like, as well as various combinations thereof. The user interface 421 may be a graphical user interface, a text-based user interface, a command-line user interface, or the like. The user interface 421 may include one or more user interface components, where the user interface components of the user interface 421 may depend on the interface type of user interface 421. For example, for a graphical user interface, the user interface components of the user interface 421 may include one or more of one or more buttons, one or more menus, one or more fillable forms (e.g., a text entry form, a spreadsheet, a form including one or more fillable fields), one or more fillable fields, or the like, as well as various combinations thereof). The user interface 421₁ may be created at a specific location(s) within a chat interface of chat application 112₁ of user device 111₁ (e.g., all within a single chat message of a single window of a chat session, distributed across multiple chat messages of a single window of a chat session, distributed across multiple windows of multiple chat sessions, or the like, as well as various combinations thereof), where the location(s) may be defined or specified in various ways (e.g., based on a message location within a window of a chat session, based on a location on a presentation interface on which the user interface 421 is presented (e.g., a specific location(s) on a television screen, a specific location(s) on a smartphone touch screen display, or the like), or the like, as well as various combinations thereof). The user interface 421 may be created by defining a bounding region within which the user interface 421 is to be created and creating the one or more user interface components of the user interface 421 within the bounding region. The user interface 421 may be created by defining one or more bounding sub-regions within a bounding region defined for the user interface 421 and creating the one or more user interface components of the user interface 421 within the one or more bounding sub-region (e.g., each user interface component within a respective bounding sub-region, multiple user interface components within a given bounding sub-region, one user interface component created using multiple bounding sub-regions, or the like, as well as various combinations thereof). The creation of user interface 421 may include definition of actions associated with the one or more user interface components of user interface 421 (e.g., pressing a VOLUME UP user interface component of user interface 421 causes the volume of the associated device to increase, pressing a PRINT user interface component of user interface 421 causes an associated document to be printed, or the like), such that interaction by human entity 110₁ (or any other user with access to user device 111₁) with user interface 421 results in initiation of the associated actions. The creation of user interface 421 may include generating imagery for display of the user interface 421 and propagating the imagery toward a presentation interface of user device 111₁ that is displaying chat application 112₁ and, thus, via which the user interface 421 is to be displayed.

The user interface 421, once created, may be used by human entity 110₁ (or any other user with access to user device 111₁) in a manner that will be understood by one skilled in the art (e.g., pointing and clicking with a mouse or other selecting mechanism, using a finger or stylus to press a touch screen display, using a voice-activated selection mechanism, or the like, as well as various combinations thereof), where it will be appreciated that the manner in which the user interface 421 is used may depend on the one or more factors (e.g., the device type of user device 111₁, the device capabilities of user device 111₁, the design or purpose of user interface 421, or the like, as well as various combinations thereof). The user interface 421 may be configured to enable human entity 110₁ (or any other user with access to user device 111₁) to control one or more controlled entities (e.g., an application, a device, or the like, as well as various combinations thereof). For example, the user interface 421 may be a user interface for controlling one or more of program entity 110₄ of device 111₄, a different application or program entity of device 111₄, device 111₄, an application or program associated with program entity 110₄ or device 111₄ (e.g., a video recorder control application or program where program entity 110₄ is a television viewing control entity), a device associated with program entity 110₄ or device 111₄ (e.g., a printer where program entity 110₄ is a print control entity), a different chat-based entity accessible via chat-based core 130, an application or device not accessible via chat-based core 130, or the like, as well as various combinations thereof. The communication between user interface 421 and the one or more controlled entities, based on interaction by the human entity 110₁ (or any other user with access to user device 111₁) with user interface 421 may be propagated via chat message, non-chat messages, or the like, as well as various combinations thereof.

The manner in which user interface creation application module 410 and user interface creation client module 420 may be used by application developers (e.g., via one or more Application Programming Interfaces (APIs) and chat participants may be further understood with respect to the following examples.

In at least some embodiments, user interface creation application module 410 may provide an API for application developers, allowing the application developers to develop and provide information which may be used by user interface creation client module 420 to create the user interface 421. As previously discussed, the information may include one or more of executable code, data, or the like. The user interface creation client module 420 may use the information to create the user interface 421. As previously discussed, for example, the user interface could be created within a region of a display screen of a device corresponding to a message “bubble” of a chat message within a chat application running on the device. The operation of user interface creation application module 410 and user interface creation client module 420 in creating user interface 421 based on executable code or data (or a combination thereof) may be further understood with respect to the following examples.

In at least some embodiments, user interface creation application module 410 may provide application developers with an API configured to enable the application developers to specify data which may be used by user interface creation client module 420 to create a user interface. The data may include region specifications that specify one or more bounding sub-regions within an encompassing bounding region for display of graphical objects and the handling of input events via the graphical objects. The user interface creation client module 420 may then use these region specifications to generate user interface displays of the objects and to handle user input events in the specified regions.

For example, a developer of a smartphone-based game could use the API of the user interface creation application module 410 to specify data which may be used by the user interface creation client module 420 on a smartphone to create a game control interface which enables interaction by a user of the smartphone with the game. For example, for the smartphone-based game, four distinct bounding sub-regions may be created within a bounding region in order to provide the user with “up,” “down,” “left,” and “right” buttons on the display screen of the smartphone, and the four bounding sub-regions may be configured to handle corresponding touches to those regions of the display screen so that the user can move a graphical element of the game on the display screen of the smartphone. In this example for the smartphone-based game, the game control interface may be created responsive to (1) the first chat participant (e.g., the owner of the smartphone or another user using the smartphone) using a chat application on the smartphone to send a chat message to a “software buddy” acting as a representative or agent for the game where the first chat message indicates that the first chat participant would like to play the game, (2) the user interface creation application module associated with the “software buddy” acting as the representative or agent for the game generating and sending a response message that includes region specification data describing the bounding region for the game control interface and the four bounding sub-regions for the four game control buttons of the game control interface, and (3) the user interface creation client module on the smartphone using executable code to generate the game control interface on the smartphone based on the region specification data describing the bounding region for the game control interface and the four bounding sub-regions for the four game control buttons of the game control interface.

For example, a developer of a smartphone-based video recorder application could use the API of the user interface creation application module 410 to specify data which may be used by the user interface creation client module 420 on a smartphone to create a video recorder control interface which enables interaction by a user of the smartphone with the video recorder (e.g., a physical video recorder device at the location of the user, software executing in a cloud to provide a cloud-based video recorder service, or the like). For example, for the smartphone-based video recorder control application, six distinct bounding sub-regions may be created within a bounding region in order to provide the chat participant with user interface controls so that the user can search for video content and control playback of selected video content via the video recorder. For example, a first bounding sub-region created within the bounding region may include user interface components supporting a video content “search” capability (e.g., a fillable field in which the user may specify one or more search criteria for identifying video content currently stored by the video recorder and, thus, available for playback to the user and a “submit” button configured to handle submission of the search for video content based on the search criteria entered by the user in the fillable field). For example, the five other bounding sub-region created within the bounding region may include “play,” “pause,” “back,” “fast forward,” and “fast back” control buttons on the display screen of the smartphone, and the five bounding sub-regions may be configured to handle corresponding touches to those regions of the display screen so that the user can control playback of video content from the video recorder (e.g., video content specified by interaction by the user with the user interface components supporting the video content “search” capability). In this example for the smartphone-based video recorder control application, the video recorder control interface may be created responsive to (1) the first chat participant (e.g., the user of the smartphone or another user using the smartphone) using a chat application on the smartphone to send a chat message to a “software buddy” acting as a representative or agent for a video recorder where the first chat message indicates that the first chat participant would like to interact with the video recorder, (2) the user interface creation application module associated with the “software buddy” acting as the representative or agent for the video recorder generating and sending a response message that includes region specification data describing the bounding region for the video recorder control interface and the five bounding sub-regions for the five video recorder control buttons of the video recorder control interface, and (3) the user interface creation client module on the smartphone using executable code to generate the video recorder control interface on the smartphone based on the region specification data describing the bounding region for the video recorder control interface and the five bounding sub-regions for the five video recorder control buttons of the video recorder control interface.

In at least some embodiments, user interface creation application module 410 may provide application developers with an API configured to enable the application developers to specify executable code which may be executed by user interface creation client module 420 to create a user interface. The executable code may configured to support creation of one or more bounding sub-regions within an encompassing bounding region for display of graphical objects and the handling of input events via the graphical objects. The user interface creation client module 420 may then execute the executable code in order to generate user interface displays of the objects and to handle user input events in the specified regions.

For example, a developer of a smartphone-based drone control application could use the API of the user interface creation application module 410 to write executable code which may be executed by the user interface creation client module 420 on a smartphone to create a drone control interface. For example, for the smartphone-based drone control application, various bounding sub-regions may be created within a bounding region in order to provide the chat participant with user interface controls so that the user can control the flight of a drone. For example, various bounding sub-regions may be created within the bounding region for controlling speed, roll, pitch, yaw, altitude, and various other characteristics associated with controlling the flight of a drone. In this example for the smartphone-based drone control application, the drone control interface may be created responsive to (1) the first chat participant (e.g., the owner of the smartphone or another user using the smartphone) using a chat application on the smartphone to send a chat message to a “software buddy” acting as a representative or agent for a drone where the first chat message indicates that the first chat participant would like to control the flight of a specified drone, (2) the user interface creation application module associated with the “software buddy” acting as the representative or agent for the drone generating and sending a response message that includes code for the drone control interface, and (3) the user interface creation client module on the smartphone receiving and executing the code to generate the drone control interface on the smartphone such that the user of the smartphone may control the drone via the drone control interface. For this example it is noted that, while control of the drone is via the chat-based system, the fact that control of the drone is via the chat-based system may be transparent to the user of the smartphone (e.g., from the perspective of the user of the smartphone, the drone control interface appears to provide direct access to the drone (e.g., the user of the smartphone does not directly perceive that interaction with the drone is via the chat-based system)).

For example, a developer of a smartphone-based computer diagnostic application could use the API of the user interface creation application module 410 to write executable code which may be executed by the user interface creation client module 420 on a smartphone to create a computer diagnostic control interface. For example, for the smartphone-based computer diagnostic control application, a menu-based window may be created within a bounding region in order to provide the computer diagnostic person with user interface controls so that the computer diagnostic person may access the computer remotely and control some diagnostic programs on the computer. In this example for the computer diagnostic application, the computer diagnostic control interface may be created responsive to (1) the first chat participant (e.g., a user of the computer) using a chat application on the computer to send a chat message to a “software buddy” acting as a representative or agent for a remote computer diagnostic application where the first chat message indicates that the first chat participant would like to provide a computer diagnostic person with remote network access to the computer so that the diagnostic person can send commands to the computer in order to diagnose any problems present on the computer, (2) the user interface creation application module associated with the “software buddy” acting as the representative or agent for the remote computer diagnostic application generating and sending a response message that includes code for the computer diagnostic control interface, and (3) the user interface creation client module on the computer receiving and executing the code to generate the computer diagnostic control interface on the computer such that the computer diagnostic person may access the computer remotely and control some diagnostic programs on the computer.

It will be appreciated that the foregoing examples discuss merely a few of the various types of applications and services for which user interfaces may be created.

It will be appreciated that, while the foregoing examples primarily discuss use of executable code or data for creation of a user interface, a combination of executable code and data may be used for creation of a user interface.

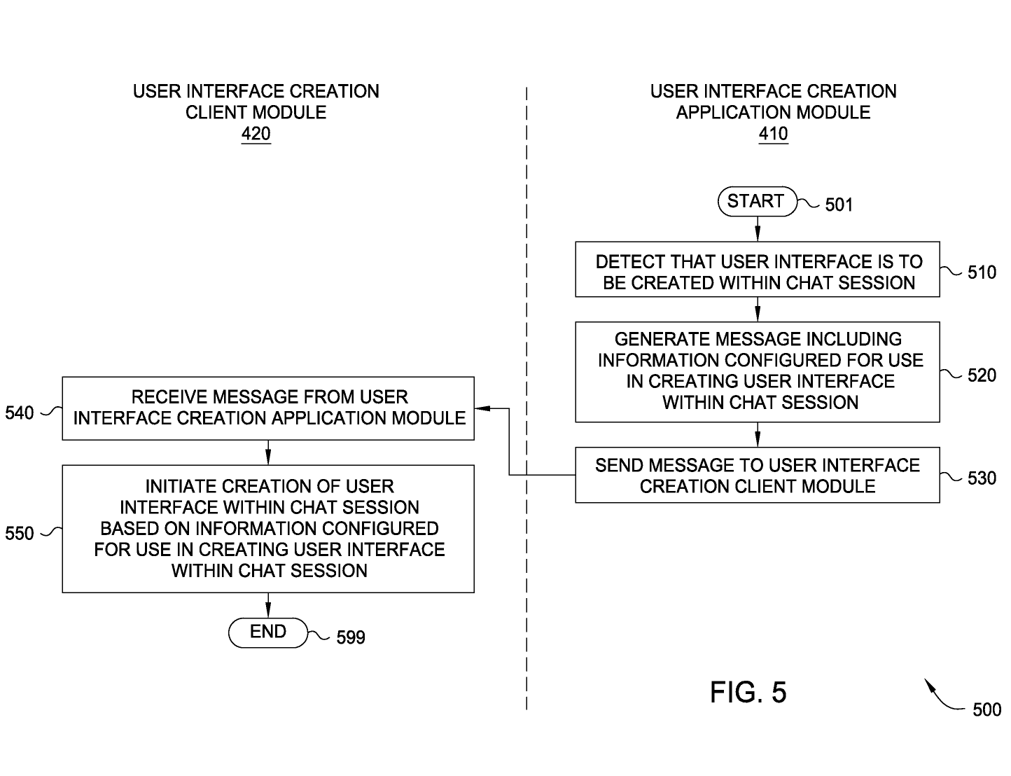

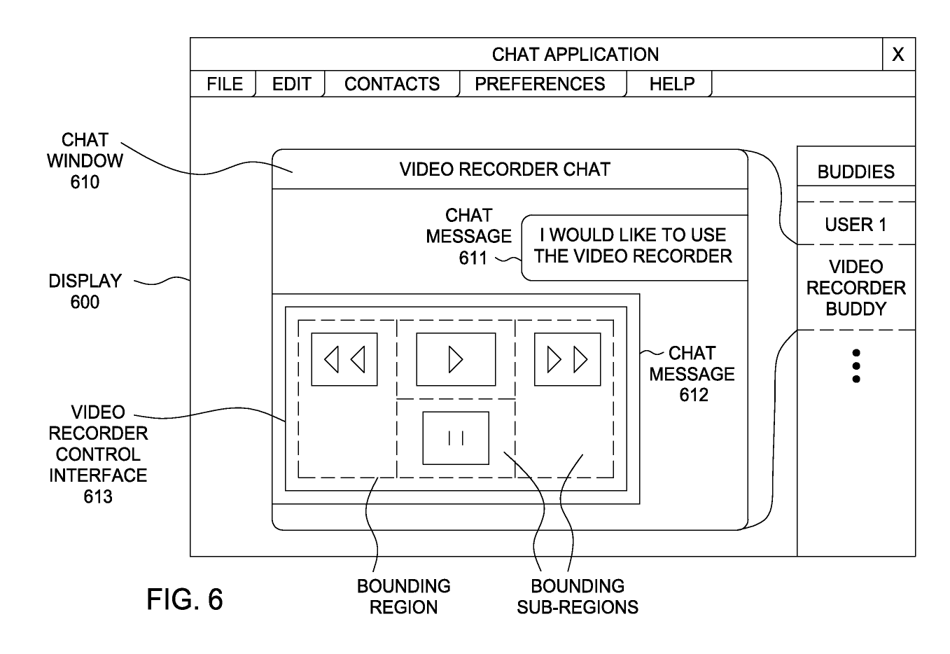

FIG. 5 depicts an exemplary embodiment of a method for supporting user interface encapsulation within a chat session supported by a chat-based system. As depicted in FIG. 5, a portion of the steps of method 500 are performed by a user interface creation application module and a portion of the steps of method 500 are performed by a user interface creation client module. It will be appreciated that, although primarily depicted and described as being performed serially, at least a portion of the steps of method 500 may be performed contemporaneously or in a different order than as presented in FIG. 5. At step 501, method 500 begins. At step 510, the user interface creation application module detects that a user interface is to be created within the chat session. At step 520, the user interface creation application module generates a message including information configured for use in creating the user interface within the chat session. At step 530, the user interface creation application module sends the message to the user interface creation client module. At step 540, the user interface creation client module receives the message from the user interface creation application module. It will be appreciated that, although primarily depicted and described with respect to embodiments in which the information configured for use in creating the user interface is communicated within a message, as previously discussed, the information configured for use in creating the user interface may be communicated in other ways. At step 550, the user interface creation client module initiates creation of the user interface within the chat session based on the information configured for use in creating the user interface within the chat session. The user interface creation client module initiates may create the user interface within the chat session or may trigger one or more other elements or functions to create the user interface within the chat session. At step 599, method 500 ends. It will be appreciated that the steps of method 500 may be further understood by way of reference to FIG. 4 and FIG. 6.

FIG. 6 depicts an exemplary user interface illustrating encapsulation of a user interface within a chat session supported by a chat-based system. As depicted in FIG. 6, a display 600 associated with a device running a chat application displays the chat application. The user of the device running the chat application would like to interact with a video recorder (e.g., a physical device at the location of the user, a cloud-based video recording service which can stream video content to a presentation device at the location of the user, or the like) in order to control playback of content from the video recorder. The user locates, within a buddy list of the chat application, a “software buddy” that is acting as a representative or agent for the video recorder. The user initiates a chat session with the “software buddy” that is acting as a representative or agent for the video recorder by opening a chat window 610 for the chat session and sending a chat message 611 indicative that the user would like to interact with the video recorder (e.g., a message such as “I would like to use the video recorder” which his depicted in FIG. 6, or any other suitable message). The chat message is sent to the “software buddy” acting as the representative or agent for the video recorder. The user interface creation application module associated with the “software buddy” acting as the representative or agent for the video recorder sends, via the chat session, a chat response message that includes data configured for use in generating a video recorder control interface within the chat session. It will be appreciated that, while not displayed in this example, an indication of receipt of the chat response message (e.g., a “user interface creation in progress” message, or any other suitable message) may be displayed as a separate message within the chat window 610 for the chat session of the chat application. The user interface creation client module associated with the chat application running on the device associated with the display 600 receives the chat response message including the data configured for use in generating the video recorder control interface within the context of the chat session. The user interface creation client module associated with the chat application running on the device associated with the display 600 generates, within a chat message 612 of the chat window 610 of the chat session, the video recorder control interface 613 that is configured for use by the user to interact with the video recorder. The user interface creation client module associated with the chat application running on the device associated with the display 600 generates the video recorder control interface 613 based on the data of the chat response message. In this example, the data of the chat response message describes a bounding region for the video recorder control interface 613 and four bounding sub-regions for four video recorder control buttons (illustratively, “play,” “pause,” “back,” and “forward” buttons) of the video recorder control interface 613. The bounding region for the video recorder control interface 613 may be the chat message 612, a region within the chat message 612 (illustrated in FIG. 6 using dashed lines), or the like. The four bounding sub-regions for the four video recorder control buttons are defined within the bounding region for the video recorder control interface 613 (also illustrated in FIG. 6 using dashed lines). The four bounding sub-regions for the four video recorder control buttons of the video recorder control interface 613 are configured to handle corresponding selections within those regions of the display 600 so that the user can control playback of video content via the video recorder (e.g., selection of the bounding sub-region for the “play” button causes propagation of a command to the video recorder for triggering the video recorder to play video content, selection of the bounding sub-region for the “pause” button causes propagation of a command to the video recorder for triggering the video recorder to pause video content that is being played out from the video recorder, and so forth).

It will be appreciated that, although primarily depicted and described herein as a “user interface”, the user interface that is created may be configured to enable a user to interact with one or more elements (e.g., one or more devices, one or more software programs, or the like) and, thus, in at least some embodiments, may be referred to herein as a “user interaction interface” configured to support interaction by a user with one or more elements.

It will be appreciated that, although primarily depicted and described herein with respect to creating a user interface within a chat session, various embodiments depicted and described herein for creating a user interface within a chat session also or alternatively may be used or adapted for providing one or more other functions. In at least some embodiments, for example, the information (e.g., executable code, data, or the like, as well as various combinations thereof) provided to the device also or alternatively may include information which may be used by the device for providing one or more other functions. For example, the device may receive and execute non-user-interface-generating code for providing one or more other functions. For example, the device may receive non-user-interface-generating data and execute code which uses the non-user-interface-generating data for providing one or more other functions. For example, the device may receive non-user-interface-generating code and non-user-interface-generating data, and may execute the non-user-interface-generating code which then uses the non-user-interface-generating data for providing one or more other functions. In at least some such embodiments, the non-user interface-generating code that is executed at the device may be executed within the context of the chat session (e.g., “within the bubble”) to provide the one or more other functions. The one or more other functions may be provided within the chat session, may be provided outside of the chat session while still being associated with or related to the chat session, may be unrelated to the chat session (e.g., the chat session merely provides a mechanism by which the information is provided to the device for use by the device to provide the one or more other functions), or the like, as well as various combinations thereof.

It will be appreciated that, although primarily depicted and described herein with respect to use of a chat-based system to provide chat-based functions (e.g., supporting chat between human and non-human entities, supporting user interface creation, or the like, as well as various combinations thereof), various embodiments of the chat-based system depicted and described herein (which also may be referred to more generally as a messaging platform) may be used or adapted to provide a wide range of applications and services. In other words, various embodiments of the chat-based system depicted and described herein may be used or adapted to provide a messaging platform (or, more generally, communication platform) that provides a foundation for a wide range of applications and services. For example, various embodiments of the messaging platform, in addition to or alternatively to supporting chat messaging and related functions (e.g., chats between humans, chats between humans and non-human entities (e.g., programs, devices, abstract entities such as organizations and procedures, or the like), or the like), may support various other applications and services (e.g., applications or services in which messages are used as asynchronous communications, applications or services in which messages are used as a persistent data store, or the like, as well as various combinations thereof). An example in which messages are used as asynchronous communications and messages are used as a persistent data store follows. In this example, a software developer could use the messaging platform to create an application in which a person sends a message to a buddy representing a retail enterprise (e.g., a nation-wide retailer). The message could be a request for clarification about an account balance. The message could be acknowledged by code executing as part of the buddy logic of the buddy representing the retail enterprise. Later, when a human agent at the retailer logs in for work, the buddy representing the retail enterprise could join the agent to the chat session and supply the customer account information for the person to the agent within a message (e.g., displaying this information within a bubble). Then, the agent could send a message to the customer as a “follow-up” response to the original query, again placing account information within the message (e.g., again, to be displayed within a bubble). In this example, the messaging is asynchronous and the messages include the persistent user account data. It will be appreciated that, in addition to or alternatively to supporting chat messaging and related functions, various embodiments of the messaging platform may support various other applications and services in which messages are used as asynchronous communications, messages are used as a persistent data store, or the like, as well as various combinations thereof. It will be appreciated that, in addition to or alternatively to supporting chat messaging and related functions, various embodiments of the messaging platform may support various other applications and services. It is noted that various embodiments of the messaging platform may provide a complement to web browser technology (where messages exchanged between the browser and the web servers are synchronized (through query-response associations) and are ephemeral (e.g., cookies, not the messages, provide a mechanism for data storage).

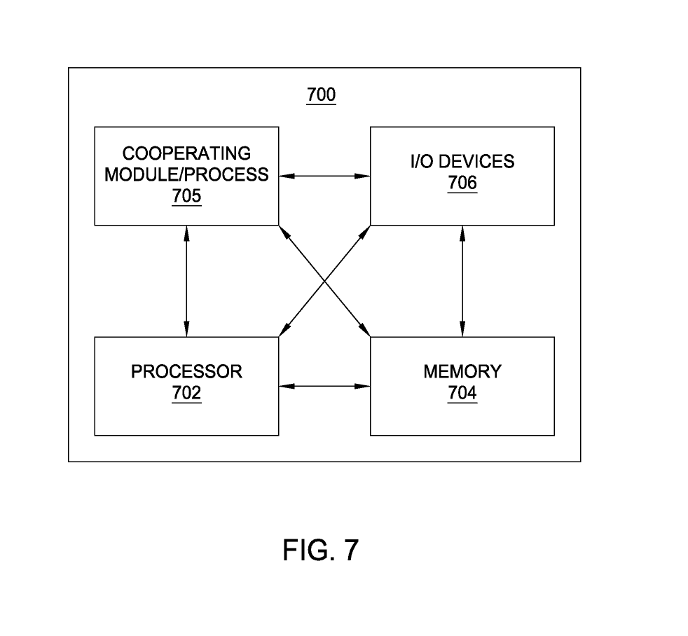

FIG. 7 depicts a high-level block diagram of a computer suitable for use in performing functions described herein.

The computer 700 includes a processor 702 (e.g., a central processing unit (CPU) and/or other suitable processor(s)) and a memory 704 (e.g., random access memory (RAM), read only memory (ROM), and the like).

The computer 700 also may include a cooperating module/process 705. The cooperating process 705 can be loaded into memory 704 and executed by the processor 702 to implement functions as discussed herein and, thus, cooperating process 705 (including associated data structures) can be stored on a computer readable storage medium, e.g., RAM memory, magnetic or optical drive or diskette, and the like.

The computer 700 also may include one or more input/output devices 706 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 700 depicted in FIG. 7 provides a general architecture and functionality suitable for implementing functional elements described herein and/or portions of functional elements described herein. For example, computer 700 provides a general architecture and functionality suitable for implementing one or more of user device 111₁, user device 111₂, one or more entity representatives 120, chat-based core 130, one or more elements of chat-based core 130, user interface creation application module 410, user interface creation client module 420, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
determine, based on detection of a trigger condition, that a user interface is to be created within a chat session supported by a chat application of a device; and
propagate, toward the device, information configured for use by the device to create the user interface within the chat session.

2. The apparatus of claim 1, wherein the trigger condition comprises at least one of a chat message being received from the device or an event independent of the chat session.

3. The apparatus of claim 1, wherein the information configured for use by the device to create the user interface within the chat session comprises at least one of:
executable code for execution by the device to create the user interface within the chat session; or
data configured for use by the device to create the user interface within the chat session.

4. The apparatus of claim 1, wherein the information configured for use by the device to create the user interface within the chat session comprises:
information configured for use by the device to create the user interface within a chat window of the chat session.

5. The apparatus of claim 1, wherein the information configured for use by the device to create the user interface within the chat session comprises:
information configured for use by the device to create the user interface within a chat message of the chat session.

6. The apparatus of claim 1, wherein the information configured for use by the device to create the user interface within the chat session comprises:
data defining a bounding region within which the user interface is to be created; and
data defining, within the bounding region, a bounding sub-region within which a user interface component of the user interface is to be created.

7. The apparatus of claim 1, wherein the processor is configured to propagate the information configured for use by the device to create the user interface within the chat session via one or more chat messages propagated within the chat session.

8. The apparatus of claim 1, wherein processor is configured to propagate the information configured for use by the device to create the user interface within the chat session via one or more non-chat messages propagated outside of the chat session.

9. The apparatus of claim 1, wherein the processor is configured to:
receive, from the device via the chat session, a chat message generated based on an interaction with the user interface.

10. A method, comprising:
using a processor and a memory for:
determining, based on detection of a trigger condition, that a user interface is to be created within a chat session supported by a chat application of a device; and
propagating, toward the device, information configured for use by the device to create the user interface within the chat session.

11. An apparatus, comprising:
a processor and a memory communicatively connected to the processor, the processor configured to:
receive, at a device comprising a chat application configured to support a chat session, information configured for use by the device to create a user interface within the chat session; and
initiate creation of the user interface within the chat session based on the information configured for use by the device to create the user interface within the chat session.

12. The apparatus of claim 11, wherein the information configured for use by the device to create the user interface within the chat session comprises at least one of:
executable code for execution by the device to create the user interface within the chat session; or
data configured for use by the device to create the user interface within the chat session.

13. The apparatus of claim 11, wherein the information configured for use by the device to create the user interface within the chat session comprises at least one of:
information configured for use by the device to create the user interface within a chat window of the chat session; or
information configured for use by the device to create the user interface within a chat message of the chat session.

14. The apparatus of claim 11, wherein the information configured for use by the device to create the user interface within the chat session comprises:
data defining a bounding region within which the user interface is to be created; and
data defining, within the bounding region, a bounding sub-region within which a user interface component of the user interface is to be created.

15. The apparatus of claim 11, wherein the processor is configured to receive the information configured for use by the device to create the user interface within the chat session via one or more chat messages propagated within the chat session.

16. The apparatus of claim 11, wherein the processor is configured to receive the information configured for use by the device to create the user interface within the chat session via one or more non-chat messages propagated outside of the chat session.

17. The apparatus of claim 11, wherein, to initiate creation of the user interface within the chat session, the processor is configured to perform at least one of:
initiate creation of the user interface within a chat window of the chat session; or
initiate creation of the user interface within a chat message of the chat session.

18. The apparatus of claim 11, wherein the processor is configured to:
detect an interaction via the user interface; and
propagate, from the device toward a second device, an indication of the interaction via the user interface.

19. The apparatus of claim 18, wherein the second device comprises an end user device or a network device.

20. A method, comprising:
using a processor and a memory for:
receiving, at a device comprising a chat application configured to support a chat session, information configured for use by the device to create a user interface within the chat session; and
initiating creation of the user interface within the chat session based on the information configured for use by the device to create the user interface within the chat session.
